(19) United States
(12) Patent Application Publication
(10) Pub. No.: US 2024/0244588 A1
(43) Pub. Date: Jul. 18, 2024

(54) TERMINAL AND COMMUNICATION METHOD

(71) Applicant: NTT DOCOMO, INC., Tokyo (JP)

(72) Inventors: Shohei Yoshioka, Chiyoda-ku, Tokyo (JP); Naoya Shibaike, Chiyoda-ku, Tokyo (JP); Satoshi Nagata, Chiyoda-ku, Tokyo (JP)

(73) Assignee: NTT DOCOMO, INC., Tokyo (JP)

(21) Appl. No.: 18/562,123

(22) PCT Filed: Mar. 22, 2022
(86) PCT No.: PCT/JP2022/013321

§ 371 Date: Nov. 17, 2023

(30) Foreign Application Priority Data
May 24, 2021 (JP) 2021-087198

(51) Int. Cl. H04W 72/02; H04W 28/26; H04W 72/25; H04W 72/512; H04W 74/0816

(52) U.S. Cl. CPC H04W 72/02; H04W 28/26; H04W 72/25; H04W 72/512; H04W 74/0816

(57) ABSTRACT

A terminal includes: a receiver configured to receive a signal from a first terminal and a second terminal in a resource pool; a controller configured to detect overlap between a first reserved resource based on a signal received from the first terminal and a second reserved resource based on a signal received from the second terminal; and a transmitter configured to transmit information relating to resource selection to the first terminal via a collision notification channel, in response to the controller detecting the overlap, wherein when the first reserved resource includes a plurality of resources, the controller determines which collision notification channel associated with a resource of the plurality of resources to use for transmitting information relating to the resource selection.

### TECHNICAL FIELD

The present invention relates to a terminal and a communication method in a wireless communication system.

### BACKGROUND ART

In the LTE (Long Term Evolution) and LTE successor systems (e.g., LTE-A (LTE Advanced), NR (New Radio) (5G)), a D2D (Device to Device) technology in which terminals communicate directly with each other without intervening a base station is under consideration (e.g., Non-Patent Document 1).

The D2D reduces the traffic between the terminal and the base station and enables communication between the terminals even when the base station is unable to communicate in the event of a disaster, etc. Although the 3GPP (3rd Generation Partnership Project) refers to D2D as “sidelink,” the term D2D is used herein more generally. However, in the description of the embodiment described below, “sidelink” is also used as needed.

The D2D communication is broadly classified into D2D discovery for discovering other terminals capable of performing communication and D2D communication (also referred to as D2D direct communication, D2D communication, direct communication between terminals, etc.) for communicating directly between terminals.

Hereinafter, when D2D communication, D2D discovery, etc. are not specifically distinguished, it is simply called D2D. A signal transmitted and received by D2D is called a D2D signal. Various use cases of V2X (Vehicle to Everything) services in NR have been studied (e.g., Non-Patent Document 2).

### RELATED ART DOCUMENTS

### Non-Patent Documents

Non-Patent Document 1: 3GPP TS 38. 211 V16.5.0 (2021-03)
Non-Patent Document 2: 3GPP TR 22. 886 V15.1.0 (2017-03)

### SUMMARY OF THE INVENTION

### Problem to be Solved by the Invention

The Enhanced Ultra Reliable Low Latency Communication (eURLLC) is being considered to enhance the NR Sidelink. For example, in the resource allocation mode 2 in which a terminal autonomously selects resources, a terminal 20A shares information representing a resource set with a terminal 20B, and the terminal 20B improves reliability of communication and reduces latency by considering the information in resource selection for transmission.

However, in resource allocation mode 2, when the transmitting side terminal performs sensing, and, for example, when another terminal exists outside the perspective of the transmitting side terminal, the quality of the resources of the receiving side terminal may differ significantly from the quality based on the result of sensing of the resources performed by the transmitting side terminal.

The present invention has been made in view of the above points, and is intended to improve the reliability of communication during autonomous resource selection in terminal-to-terminal direct communication.

### Means for Solving the Problem

According to the disclosed technique, a terminal is provided. The terminal includes:
a receiver configured to receive a signal from a first terminal and a second terminal in a resource pool;
a controller configured to detect overlap between a first reserved resource based on a signal received from the first terminal and a second reserved resource based on a signal received from the second terminal; and
a transmitter configured to transmit information relating to resource selection to the first terminal via a collision notification channel, in response to the controller detecting the overlap, wherein
when the first reserved resource includes a plurality of resources, the controller determines which collision notification channel associated with a resource of the plurality of resources to use for transmitting information relating to the resource selection.

### Effects of the Invention

According to the disclosed technique, in terminal-to-terminal direct communication, the reliability of communication upon autonomous resource selection can be improved.

### BRIEF DESCRIPTION OF THE DRAWINGS

FIG. 1 is a diagram illustrating V2X.

FIG. 2 is a diagram illustrating an example (1) of a transmission mode of V2X.

FIG. 3 is a diagram illustrating an example (2) of a transmission mode of V2X.

FIG. 4 is a diagram illustrating an example (3) of a transmission mode of V2X.

FIG. 5 is a diagram illustrating an example (4) of a transmission mode of V2X.

FIG. 6 is a diagram illustrating an example (5) of a transmission mode of V2X.

FIG. 7 is a diagram illustrating an example (1) of a communication type of V2X.

FIG. 8 is a diagram illustrating an example (2) of a communication type of V2X.

FIG. 9 is a diagram illustrating an example (3) of a communication type of V2X.

FIG. 10 is a sequence diagram illustrating an example (1) of operation of V2X.

FIG. 11 is a sequence diagram illustrating an example (2) of operation of V2X.

FIG. 12 is a sequence diagram illustrating an example (3) of operation of V2X.

FIG. 13 is a sequence diagram illustrating an example (4) of operation of V2X.

FIG. 14 is a diagram illustrating an example of a sensing operation.

FIG. 15 is a flowchart illustrating an example of a preemption operation.

FIG. 16 is a diagram illustrating an example of a preemption operation.

FIG. 17 is a diagram illustrating an example of a partial sensing operation.

FIG. 18 is a diagram illustrating an example (1) of a communication state.

FIG. 19 is a diagram illustrating an example (2) of a communication state.

FIG. 20 is a diagram illustrating an example (3) of a communication state.

FIG. 21 is a diagram illustrating an example (4) of a communication state.

FIG. 22 is a diagram illustrating an example (5) of a communication state.

FIG. 23 is a sequence diagram illustrating an example of UE-to-UE coordination in an embodiment of the present invention.

FIG. 24 is a diagram illustrating an example (1) of UE-to-UE coordination according to an embodiment of the present invention.

FIG. 25 is a diagram illustrating an example (2) of UE-to-UE coordination according to an embodiment of the present invention.

FIG. 26 is a diagram illustrating an example (3) of UE-to-UE coordination according to an embodiment of the present invention.

FIG. 27 is a diagram illustrating an example (4) of UE-to-UE coordination according to an embodiment of the present invention.

FIG. 28 is a diagram illustrating an example (5) of UE-to-UE coordination according to an embodiment of the present invention.

FIG. 29 is a diagram illustrating an example (6) of UE-to-UE coordination according to an embodiment of the present invention.

FIG. 30 is a diagram illustrating an example (7) of UE-to-UE coordination according to an embodiment of the present invention.

FIG. 31 is a diagram illustrating an example of a functional configuration of the base station 10 according to an embodiment of the present invention.

FIG. 32 is a diagram illustrating an example of a functional configuration of a terminal 20 according to an embodiment of the present invention.

FIG. 33 is a diagram illustrating an example of the hardware configuration of the base station 10 or the terminal 20 according to an embodiment of the present invention.

### EMBODIMENTS FOR CARRYING OUT THE INVENTION

Hereinafter, embodiments of the present invention will be described with reference to the accompanying drawings. The embodiments described below are examples, and the embodiments to which the present invention is applied are not limited to the following embodiments.

In operating a wireless communication system according to an embodiment of the present invention, existing technologies are used as appropriate. However, the existing technology may, for example, be an existing LTE, but is not limited to an existing LTE. The term “LTE” as used herein shall also have a broad meaning including LTE-Advanced and LTE-Advanced or later forms (e.g., NR) or WLAN (Local Area Network), unless otherwise specified.

In the embodiments of the present invention, the duplex method may be a TDD (Time Division Duplex) method, an FDD (Frequency Division Duplex) method, or any other methods (e.g., Flexible Duplex, etc.).

Further, in the embodiments of the present invention, a wireless parameter or the like being “configured” may mean that a predetermined value is pre-configured, or that a wireless parameter notified from the base station 10 or the terminal 20 is configured.

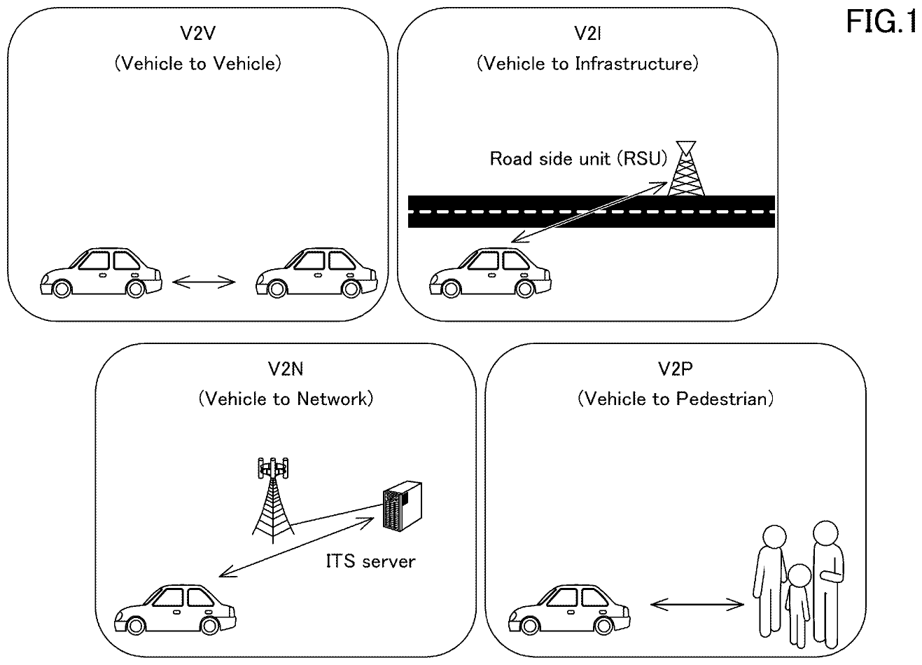

FIG. 1 is a diagram illustrating V2X. In the 3GPP, the D2D function is being extended to implement either V2X (Vehicle to Everything) or eV2X (enhanced V2X) and specification is being promoted. As illustrated in FIG. 1, V2X is a collective term for V2V (Vehicle to Vehicle), which is part of ITS (Intelligent Transport Systems), which means the form of communication between vehicles, V2I (Vehicle to Infrastructure), which means the form of communication between vehicles and road-side unit (RSU: Road-Side Unit), V2N (Vehicle to Network), which means the form of communication between vehicles and ITS servers, and V2P (Vehicle to Pedestrian), which means the form of communication between vehicles and mobile terminals owned by pedestrians.

In addition, V2X using LTE or NR cellular communication and terminal-to-terminal communication is being studied in 3GPP. V2X using cellular communication is also called cellular V2X. In NR's V2X, study is being progressed for realizing large capacity, low delay, high reliability, and QoS (Quality of Service) control.

It is assumed that, as for V2X of LTE or NR, study not limited to the 3GPP specification will be progressed in the future. For example, it is assumed that ensuring of interoperability, cost reduction by upper layer implementation, combining or switching methods for a plurality of RATs (Radio Access Technology), regulatory compliance in each country, data acquisition, distribution, database management and use method of LTE or NR V2X platforms be considered.

In the embodiments of the present invention, it is primarily assumed that a communication device is mounted on a vehicle, but the embodiments of the present invention are not limited to such embodiments. For example, the communication device may be a terminal held by a person, or the communication device may be a drone or airplane mounted device, or the communication device may be a base station, an RSU, a relay station (relay node), a terminal having scheduling capability, or the like.

Note that SL (Sidelink) may be distinguished on the basis of either UL (Uplink) or DL (Downlink) and one of 1) to 4) or a combination of 1) to 4). The SL may also be another name.
1) Resource allocation in the time domain
2) Resource allocation in the frequency domain
3) Synchronization signal (including SLSS (Sidelink Synchronization Signal)) to be referenced
4) Reference signal used for pathloss measurement for transmission power control

Also, for SL or UL OFDM (Orthogonal Frequency Division Multiplexing), either CP-OFDM (Cyclic-Prefix OFDM), DFT-S-OFDM (Discrete Fourier Transform-Spread-OFDM), OFDM without Transform precoding or OFDM with Transform precoding may be applied.

In the SL of the LTE, Mode3 and Mode4 are specified for allocating SL resources to the terminal 20. In Mode3, transmitting resources are dynamically allocated by a DCI (Downlink Control Information) transmitted from the base station 10 to the terminal 20. In Mode3, SPS (Semi Persistent Scheduling) is also possible. In Mode4, the terminal 20 autonomously selects the transmitting resource from the resource pool.

The term “slot” in the embodiments of the present invention may be replaced by “symbol”, “minislot”, “subframe”, “radio frame”, or “TTI” (Transmission Time Interval). The term “cell” in embodiments of the present invention may also be read as “cell group”, “carrier component”, “BWP”, “resource pool”, “resource”, “RAT” (Radio Access Technology), “system” (including wireless LANs), and the like.

According to the embodiments of the present invention, the terminal 20 is not limited to the V2X terminal, but may be any type of a terminal that performs D2D communication. For example, the terminal 20 may be a terminal owned by a user, such as a smartphone, or an IoT (Internet of Things) device, such as a smart meter.

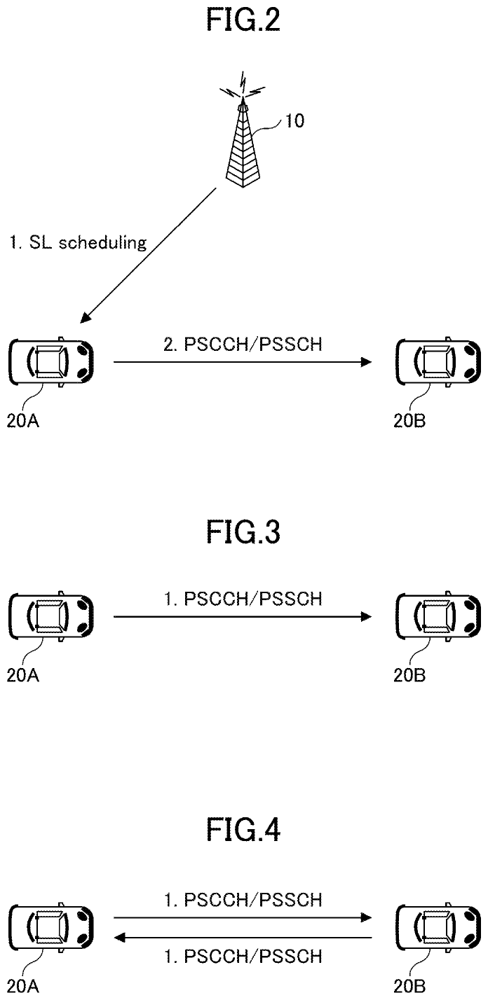

FIG. 2 is a diagram illustrating an example (1) of a transmission mode of V2X. In the sidelink communication transmission mode illustrated in FIG. 2, in step S1, the base station 10 transmits a sidelink scheduling to a terminal 20A. Subsequently, the terminal 20A transmits a PSCCH (Physical Sidelink Control Channel) and a PSSCH (Physical Sidelink Shared Channel) to a terminal 20B based on the received scheduling (step S2). The transmission mode of the sidelink communication illustrated in FIG. 2 may be referred to as sidelink transmission mode 3 in the LTE. In the sidelink transmission mode 3 in the LTE, Uu-based sidelink scheduling is performed. Uu is a radio interface between UTRAN (Universal Terrestrial Radio Access Network) and UE (User Equipment). The transmission mode of the sidelink communication illustrated in FIG. 2 may be referred to as the sidelink transmission mode 1 in the NR.

FIG. 3 is a diagram illustrating an example (2) of a transmission mode of V2X. In the sidelink communication transmission mode illustrated in FIG. 3, in step S1, the terminal 20A transmits a PSCCH and a PSSCH to the terminal 20B using autonomously selected resources. The transmission mode of the sidelink communication illustrated in FIG. 3 may be referred to as a sidelink transmission mode 4 in the LTE. In the sidelink transmission mode 4 in the LTE, the UE itself performs resource selection.

FIG. 4 is a diagram illustrating an example (3) of a transmission mode of V2X. In the sidelink communication transmission mode illustrated in FIG. 4, in step S1, the terminal 20A transmits a PSCCH and a PSSCH to the terminal 20B using autonomously selected resources. Similarly, the terminal 20B transmits a PSCCH and a PSSCH to the terminal 20A using autonomously selected resources (step S1). The transmission mode of the sidelink communication illustrated in FIG. 4 may be referred to as a sidelink transmission mode 2a in the NR. In the sidelink transmission mode 2 in the NR, the terminal 20 itself performs resource selection.

FIG. 5 is a diagram illustrating an example (4) of a transmission mode of V2X. In the sidelink communication transmission mode illustrated in FIG. 5, in step 0, the sidelink resource pattern is transmitted from the base station 10 via an RRC (Radio Resource Control) configuration to the terminal 20A or is preconfigured. Subsequently, in step S1, the terminal 20A transmits a PSSCH to the terminal 20B based on the resource pattern. The transmission mode of the sidelink communication illustrated in FIG. 5 may be referred to as a sidelink transmission mode 2c in the NR.

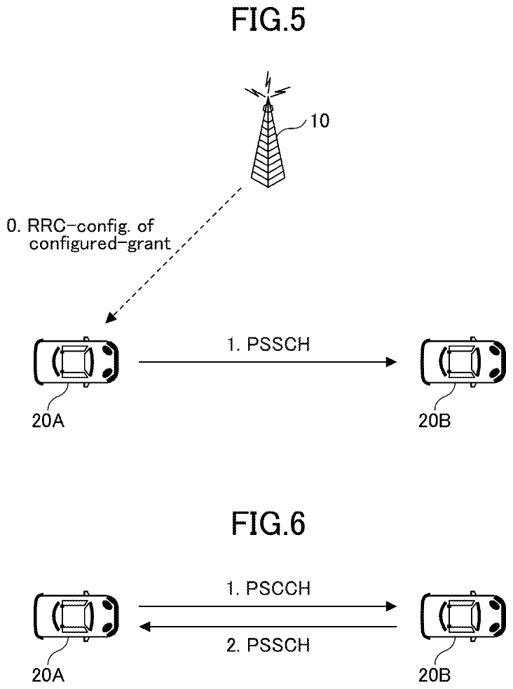

FIG. 6 is a diagram illustrating an example (5) of a transmission mode of V2X. In the sidelink communication transmission mode illustrated in FIG. 6, in step S1, the terminal 20A transmits a sidelink scheduling to the terminal 20B via a PSCCH. Subsequently, in Step 2, the terminal 20B transmits a PSSCH to the terminal 20A based on the received scheduling. The transmission mode of the sidelink communication illustrated in FIG. 6 may be referred to as a sidelink transmission mode 2d in the NR.

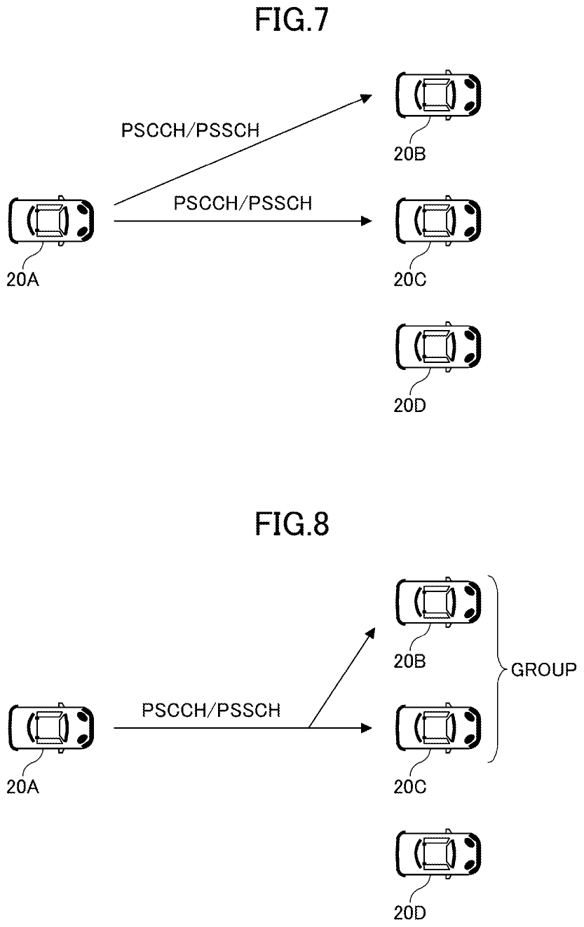

FIG. 7 is a diagram illustrating an example (1) of a communication type of V2X. The sidelink communication type illustrated in FIG. 7 is unicast. The terminal 20A transmits a PSCCH and a PSSCH to a terminal 20. In the example illustrated in FIG. 7, the terminal 20A performs unicast to a terminal 20B and performs unicast to a terminal 20C.

FIG. 8 is a diagram illustrating an example (2) of a communication type of V2X. The sidelink communication type illustrated in FIG. 8 is groupcast. The terminal 20A transmits a PSCCH and a PSSCH to a group to which one or more terminals 20 belong. In the example illustrated in FIG. 8, the group includes the terminal 20B and the terminal 20C, and the terminal 20A performs groupcast to the group.

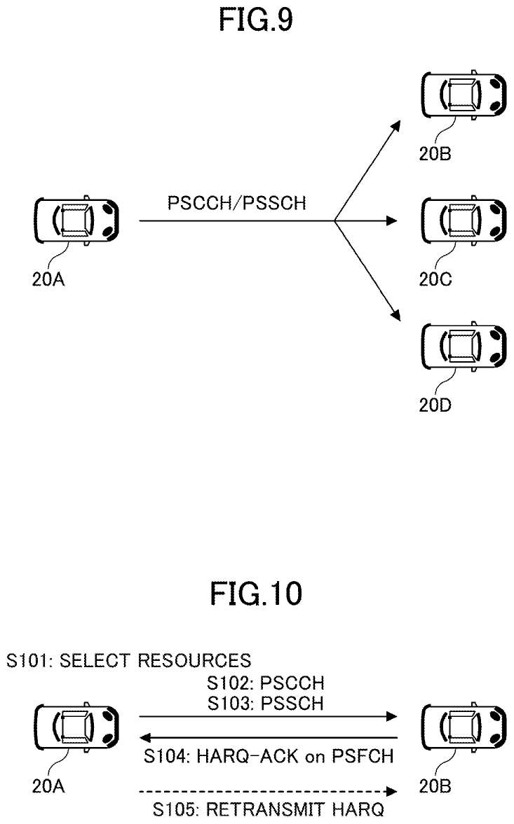

FIG. 9 is a diagram illustrating an example (3) of a communication type of V2X. The sidelink communication type illustrated in FIG. 9 is broadcast. The terminal 20A transmits a PSCCH and a PSSCH to one or more terminals 20. In the example illustrated in FIG. 9, the terminal 20A performs broadcast to the terminal 20B, the terminal 20C, and the terminal 20D. The terminal 20A illustrated in FIGS. 7 to 9 may be referred to as a header UE.

In addition, it is assumed that HARQ (Hybrid automatic repeat request) is supported for performing unicast and groupcast of sidelink in NR-V2X. In addition, SFCI (Sidelink Feedback Control Information) containing HARQ responses is defined in NR-V2X. In addition, SFCI transmission via a PSFCH (Physical Sidelink Feedback Channel) is under consideration.

In the following description, a PSFCH is used in the transmission of HARQ-ACK on the sidelink. This is an example. For example, a PSCCH may be used to transmit HARQ-ACK in the sidelink, a PSSCH may be used to transmit HARQ-ACK in the sidelink, or other channels may be used to transmit HARQ-ACK in the sidelink.

Hereinafter, for convenience, the overall information reported by the terminal 20 in the HARQ is referred to as HARQ-ACK. This HARQ-ACK may also be referred to as HARQ-ACK information. More specifically, the codebook applied to the information of the HARQ-ACK reported from the terminal 20 to the base station 10 or the like is called a HARQ-ACK codebook. The HARQ-ACK codebook defines a bit sequence of HARQ-ACK information. Note that not only ACK but also NACK is transmitted by “HARQ-ACK”.

FIG. 10 is a sequence diagram illustrating an example (1) of the operation of V2X. As illustrated in FIG. 10, a wireless communication system according to an embodiment of the present invention may include the terminal 20A and the terminal 20B. In practice, there are a number of user devices, but FIG. 10 illustrates the terminal 20A and the terminal 20B as examples.

Hereinafter, when the terminals 20A, 20B, or the like are not particularly distinguished, the term “terminal 20” or “user device” will be simply used. FIG. 10 illustrates, for example, a case where both the terminal 20A and the terminal 20B are within a cell coverage, but the operation according to the embodiments of the present invention can also be applied when the terminal 20B is outside the coverage.

As described above, in this embodiment, the terminal 20 is, for example, a device mounted in a vehicle such as an automobile and has a cellular communication function and a sidelink function as a UE of LTE or NR. The terminal 20 may be a conventional portable terminal (such as a smartphone). The terminal 20 may also be an RSU. The RSU may be a UE-type RSU having the function of a UE or a gNB-type RSU having the function of a base station apparatus.

The terminal 20 need not be a single housing device. For example, even in a case where various sensors are dispersed in a vehicle, an apparatus including the various sensors may be the terminal 20.

The processing contents of the transmission data of the sidelink of the terminal 20 are basically the same as those of UL transmission in the LTE or NR. For example, the terminal 20 scrambles the codeword of the transmitted data, modulates it to generate complex-valued symbols, and maps the complex-valued symbols (transmission signal) to one or two layers to perform precoding. The precoded complex-valued symbols are then mapped to a resource element to generate a transmission signal (e.g., complex-valued time-domain SC-FDMA signal) and transmit it from each antenna port.

The base station 10 has a function of cellular communication as a base station in the LTE or NR and a function of enabling communication of the terminal 20 according to the present embodiment (e.g., resource pool configuration, resource allocation, etc.). The base station 10 may also be an RSU (gNB-type RSU).

In a wireless communication system according to an embodiment of the present invention, the signal waveform used by the terminal 20 for SL or UL may be OFDMA, SC-FDMA, or other signal waveforms.

In step S101, the terminal 20A autonomously selects a resource to be used for PSCCH and PSSCH from a resource selection window having a predetermined period. The resource selection window may be configured from the base station 10 to the terminal 20. Here, for a predetermined period of time in the resource selection window, a time period may be specified by a terminal implementation condition, such as a processing time or a packet maximum allowable delay time, or a time period may be predefined by a specification. The predetermined time period may be referred to as an interval in the time domain.

In step S102 and step S103, the terminal 20A transmits an SCI (Sidelink Control Information) by a PSCCH and/or a PSSCH using the resources autonomously selected in step S101, and transmits SL data by the PSSCH. For example, the terminal 20A may transmit the PSCCH using a frequency resource adjacent to a PSSCH frequency resource with a time resource the same as at least a portion of a time resource of the PSSCH.

The terminal 20B receives the SCI (PSCCH and/or PSSCH) and the SL data (PSSCH) transmitted from the terminal 20A. The received SCI may include information relating to a PSFCH resource for the terminal 20B to transmit a HARQ-ACK for receiving of the data. The terminal 20A may perform transmission by including the information of the autonomously selected resource in the SCI.

In step S104, the terminal 20B transmits the HARQ-ACK for the received data to the terminal 20A using a PSFCH resource determined from the received SCI.

In step S105, when the HARQ-ACK received in step S104 indicates a request of retransmission, that is, when the HARQ-ACK is a NACK (negative response), the terminal 20A retransmits the PSCCH and the PSSCH to the terminal 20B. The terminal 20A may retransmit the PSCCH and the PSSCH using autonomously selected resources.

If HARQ control with HARQ feedback is not performed, step S104 and step S105 may not be performed.

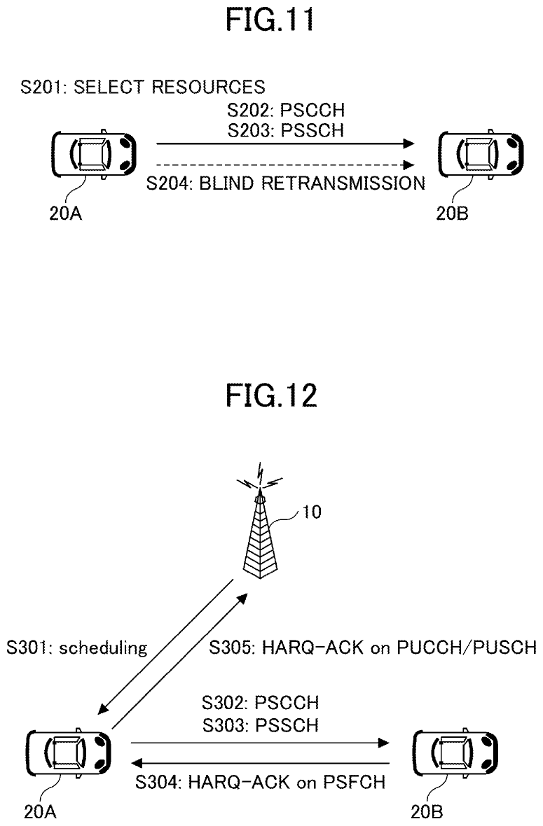

FIG. 11 is a sequence diagram illustrating an example (2) of the operation of V2X. Non-HARQ controlled blind retransmissions may be performed to improve a transmission success rate or a reachable distance.

In step S201, the terminal 20A autonomously selects resources for use for PSCCH and PSSCH from a resource selection window having a predetermined period of time. The resource selection window may be configured from the base station 10 to the terminal 20.

In step S202 and step S203, the terminal 20A transmits an SCI by a PSCCH and/or a PSSCH and transmits SL data by the PSSCH, using the resources autonomously selected in step S201. For example, the terminal 20A may transmit the PSCCH using a frequency resource adjacent to a frequency resource of the PSSCH with a time resource the same as at least a portion of a time resource of the PSSCH.

In step S204, the terminal 20A retransmits the SCI by the PSCCH and/or the PSSCH and the SL data by the PSSCH to the terminal 20B using resources autonomously selected in step S201. Retransmission in step S204 may be performed multiple times.

If the blind retransmission is not performed, step S204 may not be performed.

FIG. 12 is a sequence diagram illustrating an example (3) of an operation of V2X. The base station 10 may perform scheduling in sidelink. That is, the base station 10 may determine a sidelink resource to be used by the terminal 20 and transmit information representing the resource to the terminal 20. In addition, if HARQ control with HARQ feedback is applied, the base station 10 may transmit information indicative of a PSFCH resource to the terminal 20.

In step S301, the base station 10 performs SL scheduling by transmitting a DCI (Downlink Control Information) to the terminal 20A via a PDCCH. Thereafter, for convenience, the DCI for SL scheduling is called SL scheduling DCI.

In step S301, it is also assumed that the base station 10 transmits a DCI for DL scheduling (may be referred to as DL allocation) to the terminal 20A by a PDCCH. Thereafter, for convenience, the DCI for DL scheduling is referred to as a DL scheduling DCI. The terminal 20A receiving the DL scheduling DCI receives DL data by a PDSCH using a resource specified in the DL scheduling DCI.

In step S302 and step S303, the terminal 20A transmits an SCI (Sidelink Control Information) via a PSCCH and/or a PSSCH using the resource specified in the SL scheduling DCI and transmits SL data via the PSSCH. Note that in the SL scheduling DCI, only PSSCH resources may be specified. In this case, for example, the terminal 20A may transmit the PSCCH using a frequency resource adjacent to a frequency resource of the PSSCH with a time resource the same as at least a portion of a time resource of the PSSCH.

The terminal 20B receives the SCI (PSCCH and/or PSSCH) and the SL data (PSSCH) transmitted from the terminal 20A. The SCI received by the PSCCH and/or the PSSCH includes information of a resource of a PSFCH for the terminal 20B to transmit a HARQ-ACK for reception of the data.

The information of the resource is included in the DL scheduling DCI or the SL scheduling DCI transmitted from the base station 10 in step S301, and the terminal 20A acquires the information of the resource from the DL scheduling DCI or the SL scheduling DCI and includes it in the SCI. Alternatively, the DCI transmitted from the base station 10 does not include the information of the resource, and the terminal 20A may autonomously include the information of the resource in the SCI and transmit the information of the resource.

In step S304, the terminal 20B transmits the HARQ-ACK for the received data to the terminal 20A using a PSFCH resource determined from the received SCI.

In step S305, the terminal 20A transmits the HARQ-ACK using a PUCCH (Physical uplink control channel) resource designated by the DL scheduling DCI (or SL scheduling DCI) for example at the timing (e.g., slot-by-slot timing) specified by the DL scheduling DCI (or SL scheduling DCI), and the base station 10 receives the HARQ-ACK. A codebook of the HARQ-ACK codebook may include HARQ-ACK received from the terminal 20B or HARQ-ACK that is not received and that is generated based on a PSFCH, and HARQ-ACK for DL data. However, HARQ-ACK for DL data is not included if DL data is not allocated. In NR Rel.16, the codebook of the HARQ-ACK does not include HARQ-ACK for DL data.

Note that if HARQ control with HARQ feedback is not performed, step S304 and/or step S305 may not be performed.

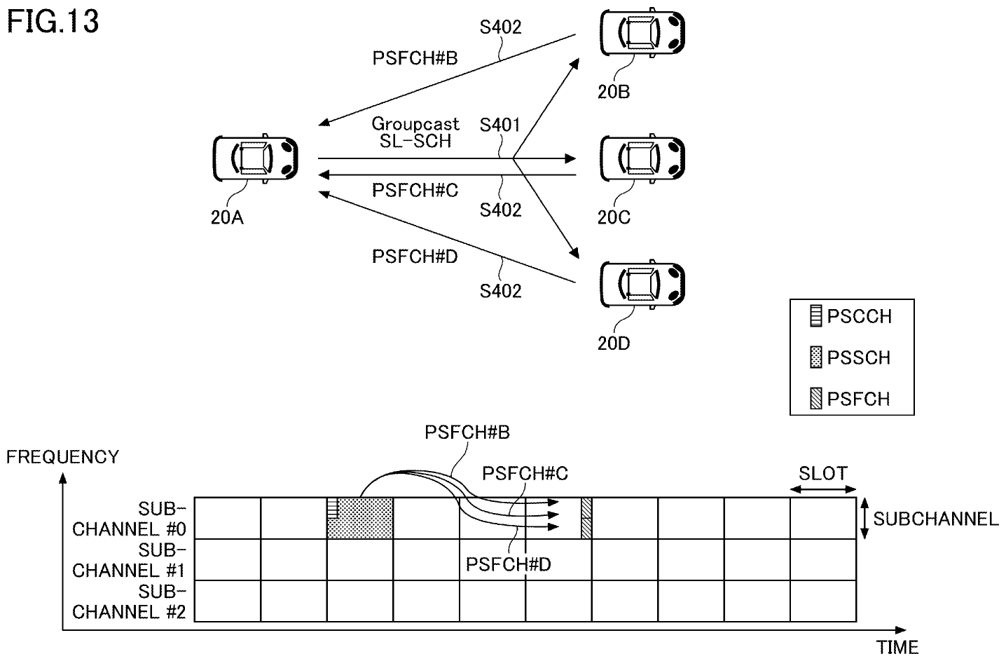

FIG. 13 is a sequence diagram illustrating an example (4) of an operation of V2X. As noted above, it is supported that a HARQ response is transmitted by a PSFCH in sidelink of NR. For example, the format of the PSFCH can be the same as that of a PUCCH (Physical Uplink Control Channel) format 0. That is, the PSFCH format may be a sequence-based format with a PRB (Physical Resource Block) size of 1 in which ACK and NACK are identified by differences of sequences and/or cyclic shifts. PSFCH formats are not limited to this example. A PSFCH resource may be located at an end symbol of a slot or at a plurality of symbols at the end of the slot. A period N is configured or predefined for the PSFCH resource. The period N may be configured or predefined in units of slots.

In FIG. 13, the vertical axis corresponds to the frequency domain and the horizontal axis corresponds to the time domain. The PSCCH may be allocated to one symbol at the beginning of the slot, to a plurality of symbols from the beginning of the slot, or to a plurality of symbols other than the beginning of the symbols. The PSFCH may be located at one symbol at the end of the slot or at multiple symbols at the end of the slot. Note that, the above-described “the beginning of the slot” and “the end of the slot” may omit consideration of symbols for AGC (Automatic Gain Control) and symbols for transmission/reception switching. That is, when, for example, one slot consists of 14 symbols, “the beginning of the slot” and “the end of the slot” may mean that a first symbol and a last symbol, respectively, in 12 symbols obtained by excluding a first symbol and a last symbol from the 14 symbols. In the example illustrated in FIG. 13, three subchannels are configured to the resource pool, and two PSFCHs are placed after three slots from the slot in which the PSSCH is placed. The arrows from PSSCH to PSFCH indicate an example of PSFCH associated with PSSCH.

If the HARQ response in the NR-V2X groupcast is a groupcast option 2 that transmits ACK or NACK, the resource used to send and receive a PSFCH need to be determined. As illustrated in FIG. 13, in step S401, the terminal 20A, which is the transmitting side terminal 20, performs groupcast to the terminal 20B, the terminal 20C, and the terminal 20D, which is the receiving side terminals 20, through a SL-SCH. In step S402, the terminal 20B uses PSFCH #B, the terminal 20C uses PSFCH #C, and the terminal 20D uses PSFCH #D to transmit a HARQ response to the terminal 20A. Here, as illustrated in the example of FIG. 13, if the number of PSFCH resources available is less than the number of receiving side terminals 20 belonging to the group, it is necessary to determine how to allocate PSFCH resources. The transmitting side terminal 20 may identify the number of the receiving side terminals 20 in the groupcast. In groupcast option 1, only NACK is transmitted as a HARQ response, and no ACK is transmitted.

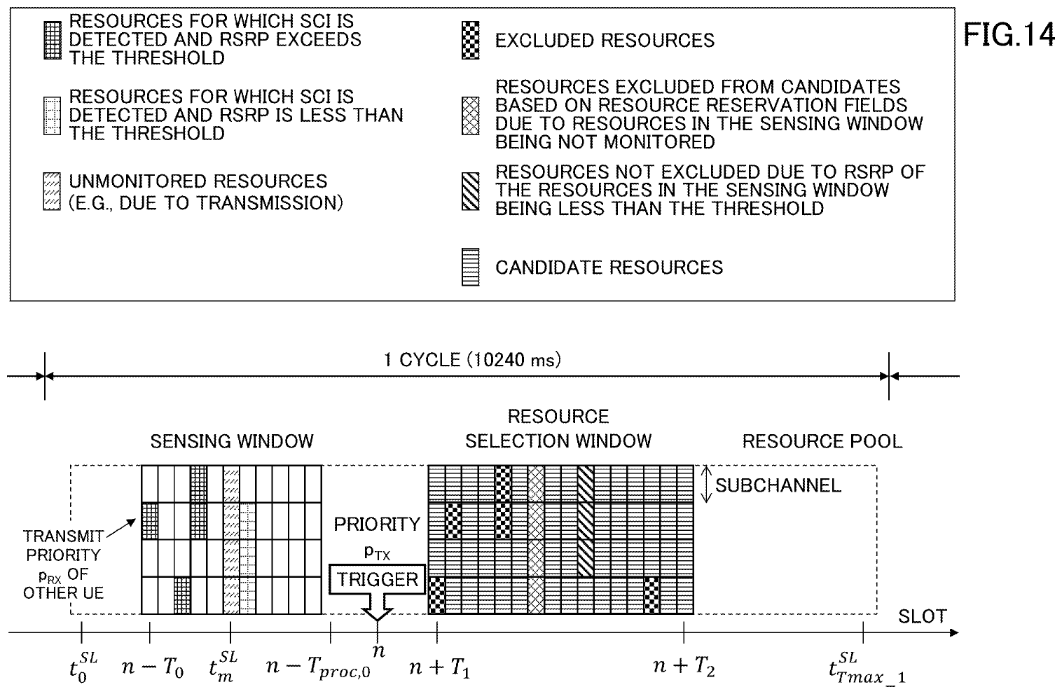

FIG. 14 is a diagram illustrating an example of a sensing operation in NR. In a resource allocation mode 2, the terminal 20 selects a resource and transmits the selected resource. As illustrated in FIG. 14, the terminal 20 performs sensing in a sensing window in a resource pool. By sensing, the terminal 20 receives a resource reservation field or a resource allocation field contained in the SCI transmitted from the other terminal 20 and identifies available resource candidates in the resource selection window in the resource pool based on the field. The terminal 20 then randomly selects resources from the available resource candidates.

The configuration of the resource pool may also have a period, as illustrated in FIG. 14. For example, the period may be a period of 10240 milliseconds. FIG. 14 is an example in which slot t₀^{SL} to slot t_{Tmax-1}^{SL} are configured as a resource pool. Regions may be configured, for example, by a bitmap in the resource pool within each period.

Further, as illustrated in FIG. 14, the transmission trigger at the terminal 20 occurs at the slot n, and the priority of the transmission is p_{TX}. The terminal 20 can detect, for example, that the other terminal 20 is performing transmission of the priority p_{RX} in the sensing window from the slot n−T₀ to the slot immediately preceding the slot n-T_{proc,0}. If the SCI is detected in the sensing window and the RSRP (Reference Signal Received Power) is above the threshold, resources in the resource selection window corresponding to the SCI are excluded. Also, if the SCI is detected in the sensing window and the RSRP is below the threshold, resources in the resource selection window corresponding to the SCI are not excluded. The threshold may be, for example, Th_{pTX, pRX}, which is configured or defined for each resource in the sensing window based on the priority p_{TX} and the priority p_{RX}.

In addition, like the slot tₙ^{SL} illustrated in FIG. 14, resources in the resource selection window that are candidates for resource reservation information corresponding to resources in the sensing window that has not been monitored are excluded, for example, for transmission.

In the resource selection window from the slot n+T₁ to the slot n+T₂, as illustrated in FIG. 14, resources occupied by the other UE are identified, and resources from which the identified resources are excluded become available resource candidates. Assuming that a set of available resource candidates is S_{A}, if S_{A} is less than 20% of the resource selection window, the threshold Th_{pTX, pRX} that is set for each resource in the sensing window may be increased by 3 dB to perform resource identification again. That is, by performing resource identification again by increasing the threshold Th_{pTX, pRX}, the resources that are not excluded because RSRP is below the threshold are increased, and the set S_{A} of resource candidates may become 20% or more of the resource selection window. The operation of performing resource identification again by increasing the threshold Th_{pTX, pRX} set for each resource in the sensing window by 3 dB if S_{A} is less than 20% of the resource selection window, may be repeated.

The lower layer of the terminal 20 may report the S_{A} to the higher layer. The higher layers of the terminal 20 may perform random selection for the S_{A} to determine resources to be used. The terminal 20 may perform sidelink transmission using the determined resources.

Although FIG. 14 above illustrates the operation of the transmitting side terminal 20, the receiving side terminal 20 may detect data transmission from the other terminal 20 and receive data from the other terminal 20 based on the results of sensing or partial sensing.

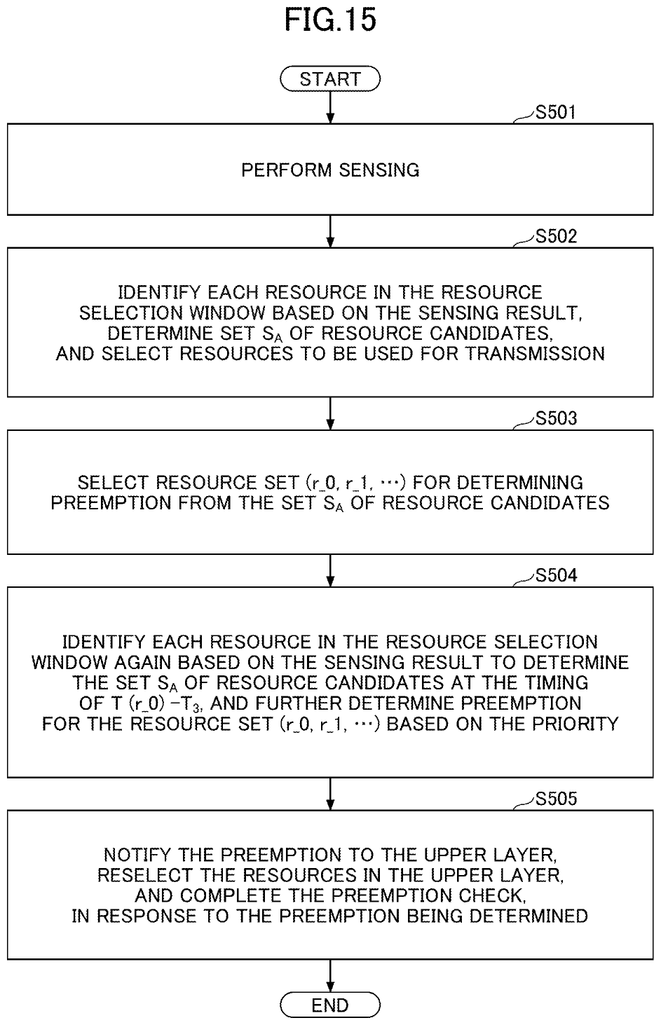

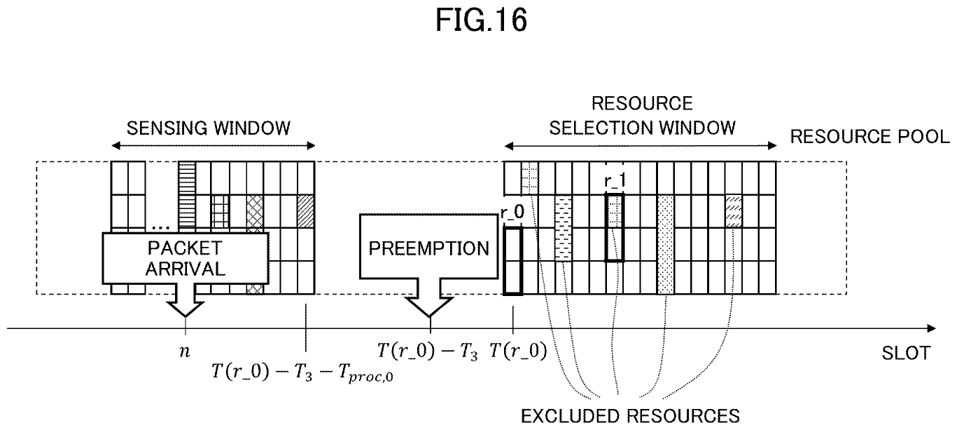

FIG. 15 is a flowchart illustrating an example of preemption in NR. FIG. 16 is a diagram illustrating an example of preemption in NR. In step S501, the terminal 20 performs sensing in the sensing window. Sensing may be performed for a predetermined limited period of time when the terminal 20 performs power saving operations. Subsequently, the terminal 20 identifies each resource in the resource selection window based on the sensing result, determines a set S_{A} of resource candidates, and selects a resource to be used for transmission (S502). Subsequently, the terminal 20 selects the resource set (r_0, r_1, . . . ) for determining the preemption from the set S_{A} of resource candidates (S503). The resource set may be notified from the higher layer to the PHY layer as resources for which whether preempted or not is determined.

In step S504, at the timing of T(r_0)−T₃ illustrated in FIG. 16, the terminal 20 again identifies each resource in the resource selection window based on the sensing result and determines a set S_{A} of resource candidates, and further determines preemption for the resource set (r_0, r_1, . . . ) based on a priority. For example, as for r_1 illustrated in FIG. 16 an SCI transmitted from the other terminal 20 is detected by sensing again, so that r_1 is not included in the S_{A}. When the preemption is valid, and the value prio_RX representing the priority of the SCI transmitted from the other terminal 20 is lower than the value prio_TX representing the priority of the transport block transmitted from the own terminal, the terminal 20 determines that the resource r_1 has been preempted. The priority is higher when the value indicating the priority is lower. That is, when the value prio_RX representing the priority of the SCI transmitted from the other terminal 20 is higher than the value prio_TX representing the priority of the transport block transmitted from the own terminal, the terminal 20 does not exclude the resource r_1 from the S_{A}. Alternatively, if the preemption is valid only for a specific priority (for example, sl-PreemptionEnable is any one of pl1, pl2, . . . , pl8), then this priority is prio_pre. At this time, when the value prio_RX representing the priority of the SCI transmitted from the other terminal 20 is lower than prio_pre, and the value prio_RX is lower than prio_TX representing the priority of the transport block transmitted from the own terminal, the terminal 20 determines that the resource r_1 has been preempted.

In step S505, when the preemption is determined in step S504, the terminal 20 notifies the higher layer of the preemption, reselects resources at the higher layer, and terminates the preemption check.

When re-evaluation (Re-evaluation) is performed instead of preemption check, in step S504, after determining the set S_{A} of resource candidates, if the S_{A} does not contain resources of the resource set (r_0, r_1, . . . ), the resource is not used and the resource is reselected at the higher layer.

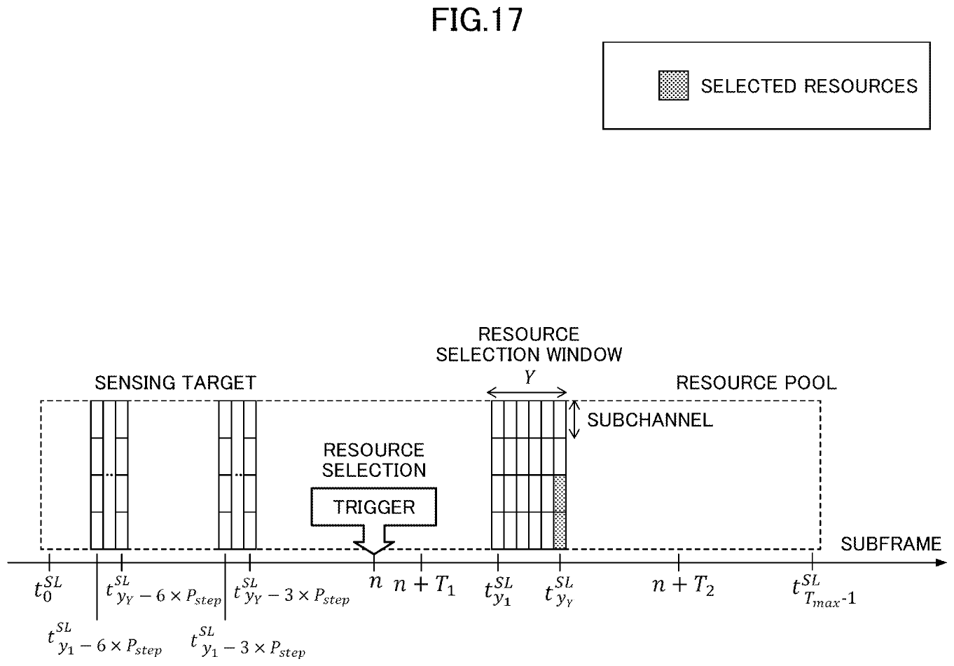

FIG. 17 is a diagram illustrating an example of a partial sensing operation in LTE. When the partial sensing is configured from the higher layer in the LTE sidelink, the terminal 20 selects a resource and performs transmission, as illustrated in FIG. 17. As illustrated in FIG. 17, the terminal 20 performs partial sensing to a portion of the sensing window, that is a sensing target, in the resource pool. By performing partial sensing, the terminal 20 receives a resource reservation field contained in the SCI transmitted from the other terminal 20 and identifies available resource candidates within the resource selection window in the resource pool based on the field. The terminal 20 then randomly selects resources from the available resource candidates.

FIG. 17 is an example in which subframes from the subframe t₀^{SL} to the subframe t_{Tmax-1}^{SL} are configured as a resource pool. Target regions may be configured by a bitmap for the resource pool, for example. As illustrated in FIG. 17, a transmission trigger at the terminal 20 is generated at the subframe n. As illustrated in FIG. 17, Y subframes, from subframe t_{y1}^{SL} to subframe t_{yY}^{SL}, from subframe n+T₁ to subframe n+T₂ may be configured as a resource selection window.

The terminal 20 can detect, for example, that the other terminal 20 is performing transmission at one or more sensing targets from the subframe t_{y1-k×Pstep}^{SL} to the subframe t_{yY-k×Pstep}^{SL}, which become Y subframe length. The k may be determined, for example, by a 10-bit bitmap. FIG. 17 illustrates an example in which the third and sixth bits of the bitmap are set to “1” indicating that partial sensing is performed. That is, in FIG. 17, from subframe t_{y1-6=Pstep}^{SL} to subframe t_{yY-6×Pstep}^{SL}, and from subframe t_{y1-3×Pstep}SL to subframe t_{yY-3×Pstep}^{SL} are configured as sensing targets. As noted above, the kth bit of the bitmap may correspond to a sensing window from subframe t_{y1-k×Pstep}^{SL} to subframe t_{yY-k×Pstep}^{SL}. Note that yᵢ corresponds to the index (1 . . . Y) in the Y subframe.

It should be noted that k is set or specified in advance with a bitmap of 10 bits, and Pₛₜₑₚ may be 100 ms. However, when SL communication is performed with DL and UL carriers, the Pₛₜₑₚ may be (U/(D+S+U)*100 ms. U corresponds to the number of UL subframes, D corresponds to the number of DL subframes, and S corresponds to the number of special subframes.

If an SCI is detected at the above sensing target and the RSRP is above the threshold, resources in the resource selection window corresponding to the resource reservation field of the SCI are excluded. Also, if the SCI is detected at the sensing target and the RSRP is below the threshold, resources in the resource selection window corresponding to the resource reservation field of the SCI are not excluded. The threshold may be, for example, Th_{pTX, pRX}, which is configured or defined for each resource in the sensing target based on the transmitting side priority p_{TX} and the receiving side priority p_{RX}.

As illustrated in FIG. 17, in the resource selection window set in the Y subframes of the interval [n+T₁, n+T₂], the terminal 20 identifies resources occupied by the other UE and resources obtained by excluding the occupied resources become usable resource candidates. The Y subframes may not be continuous. Assuming that the set of available resource candidates is S_{A}, then if S_{A} is less than 20% of the resources in the resource selection window, resource identification may be performed again by increasing the threshold Th_{pTX, pRX} set for each resource of the sensing target by 3 dB.

That is, by performing resource identification again by increasing the threshold Th_{pTX, pRX}, resources that are not excluded because RSRP is less than the threshold may be increased. In addition, RSSI of each resource in the S_{A} may be measured and a resource with the smallest RSSI may be added to the set S_{B}. The operation of adding the resource, with the smallest RSSI, included in S_{A} to the S_{B} may be repeated until the set S_{B} of the resource candidates becomes equal to or greater than 20% of the resource selection window.

The lower layer of the terminal 20 may report the S_{B} to the higher layer. The higher layer of the terminal 20 may perform random selection for the S_{B} to determine resources to be used. The terminal 20 may perform sidelink transmission using the determined resources. After the terminal 20 once keeps a resource, the terminal 20 may use the resource periodically without performing sensing a predetermined number of times (for example, Cᵣₑₛₑₗ times).

Here, power saving based on random resource selection and partial sensing is being considered in the NR release 17 sidelink. For example, for power saving, random resource selection and partial sensing of sidelink in LTE release 14 may be applied to the resource allocation mode 2 in NR release 16 sidelink. The terminal 20 to which partial sensing is applied performs reception and sensing only at specific slots in the sensing window.

In addition, eURLLC (enhanced Ultra Reliable Low Latency Communication) is being studied with inter-UE coordination as the baseline in NR release 17 sidelink. For example, the terminal 20A may share information representing a resource set with the terminal 20B, and the terminal 20B may consider the information in resource selection for transmission.

For example, as a resource allocation method in sidelink, the terminal 20 may perform full sensing as illustrated in FIG. 14. The terminal 20 may also perform resource identification by sensing only limited resources compared to full sensing to perform partial sensing for resource selection from the identified resource set. Also, the terminal 20 may perform random selection in which the terminal 20 determines resources in the resource selection window as identified resource set without excluding resources from the resources in the resource selection window, and performs resource selection from the identified resource set.

A method in which, at the time of resource selection, random selection is performed, and at the time of reevaluation or preemption check, sensing information is used, may be treated as partial sensing or may be treated as random selection.

As operations in sensing, 1) and 2) illustrated below may be applied.

1) Periodic-based partial sensing
An operation of determining a sensing slot based on a reservation periodicity in a scheme where sensing is performed for only a portion of slots. Note that the reservation periodicity is a value relating to a resource reservation period field.

2) Contiguous partial sensing
An operation of determining a sensing slot based on an aperiodic reservation in a scheme where sensing is performed for only a portion of slots. Aperiodic reservation is a value associated with a time resource assignment field.

In the release 17, operation may be defined assuming three types of terminals 20. One is type A, and the type A terminal 20 does not have capability to receive any sidelink signals and channels. However, the type A terminal 20 may receive a PSFCH and a S-SSB as an exception.

The other is type B, and the type B terminal 20 does not have capability to receive any sidelink signals and channels except PSFCH and S-SSB reception.

The other is type D, and the type D terminal 20 has capability to receive all signals and channels of sidelink as defined in release 16. However, the type D terminal 20 does not exclude receiving of a part of sidelink signals and channels.

It should be noted that UE types other than type A, type B, and type D described above may be assumed, and the UE type may be associated with the UE capability or may not be associated with the UE capability.

In addition, in release 17, multiple resource allocation methods may be configured for a resource pool. In addition, SL-DRX (Discontinuous Reception) is supported as one of power saving functions. That is, reception operation is performed only for a predetermined interval.

In the resource allocation mode 2 in which the terminal 20 autonomously selects resources, the terminal 20 receives resource reservation information of the other terminal 20 by sensing, and the terminal 20 selects resources to be used for transmission based on the resource reservation information. However, even if each transmitting side terminal 20 makes a resource selection based on sensing, resource collision may occur. In order to improve communication reliability and reduce delays, there are communication states to be considered as illustrated below.

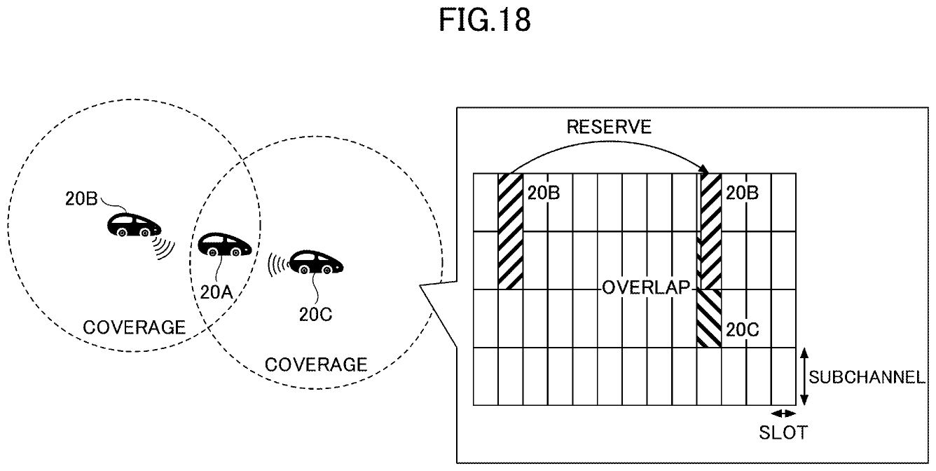

FIG. 18 is a diagram illustrating an example (1) of a communication state. As an example of the hidden terminal problem, when transmission from the terminal 20B to the terminal 20A, there is a case where the terminal 20C which cannot be detected from the terminal 20A may be located at a position where the terminal 20C interferes with the receiving side terminal 20B. For example, when the terminal 20C performs transmission in a time resource reserved by the terminal 20A, resource overlap may occur when the terminal 20B performs reception.

Further, since sidelink is a half-duplex communication, when both terminals 20 performs transmission, resource collision may occur.

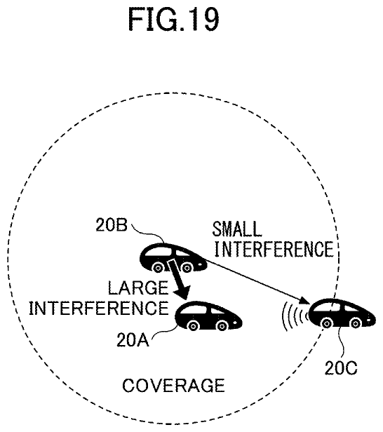

FIG. 19 is a diagram illustrating an example (2) of a communication state. As an example of the near-far problem, as illustrated in FIG. 19, when transmission from the terminal 20C to the terminal 20A is performed, there is a case in which the terminal 20B detected with a small power by the transmitting side terminal 20C may be located at a position that causes a large interference with the receiving side terminal 20A.

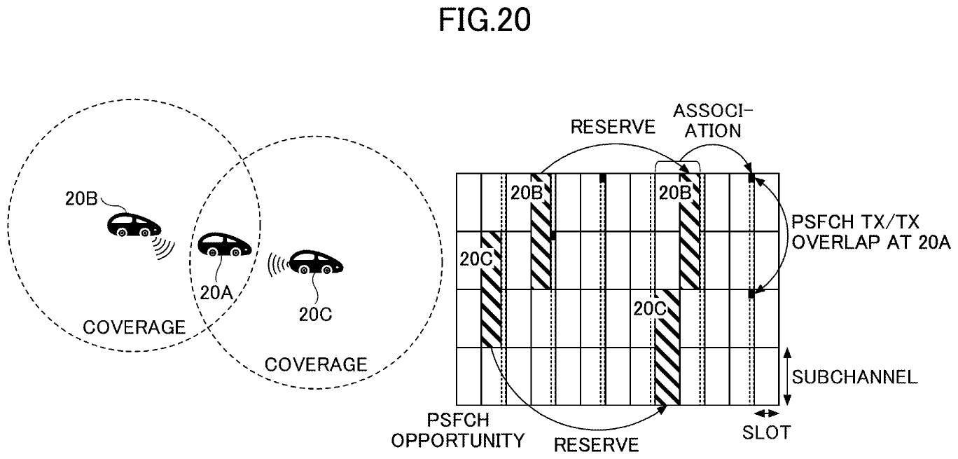

FIG. 20 is a diagram illustrating an example (3) of a communication state. As an example of collision between a transmitting resource and a transmitting resource in the time domain, as illustrated in FIG. 20, a PSFCH transmitting resource reserved from the terminal 20B or associated with a PSSCH and a PSFCH transmitting resource reserved from the terminal 20C or associated with a PSSCH may overlap at the terminal 20A. Drop or power reduction occurs when multiple transmissions overlap. For example, overlap of a PSFCH and another PSFCH, or overlap of a PSFCH and an UL channel may occur.

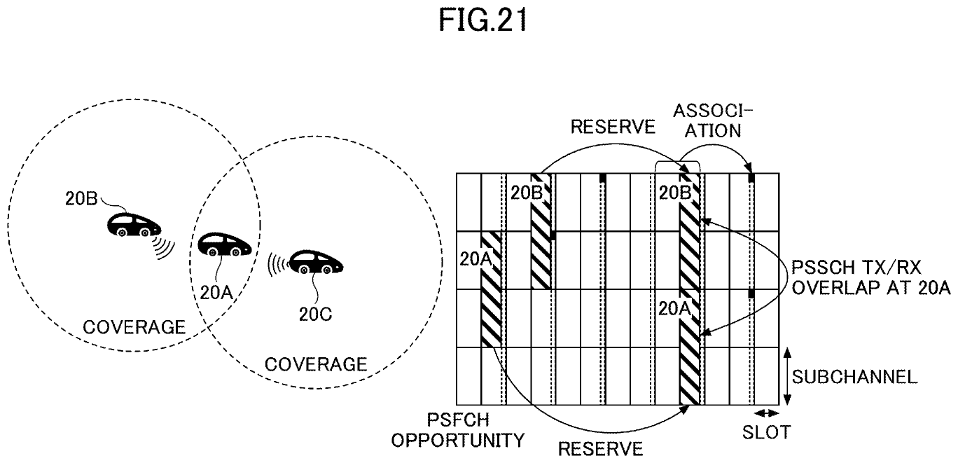

FIG. 21 is a diagram illustrating an example (4) of a communication state. As an example of collision between a reception resource and a transmission resource in the time domain, as illustrated in FIG. 21, PSSCH reception in a reserved resource from the terminal 20B and PSSCH transmission in a reserved resource from the terminal 20A may overlap at the terminal 20A.

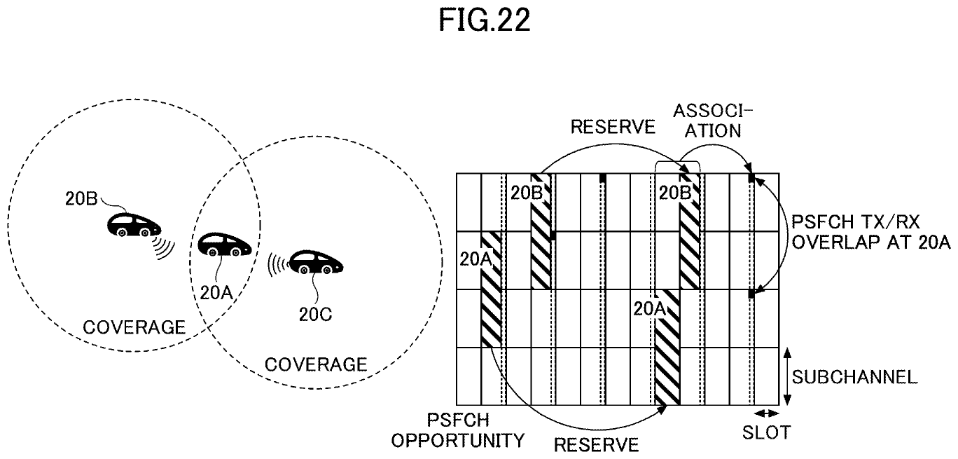

FIG. 22 is a diagram illustrating an example (5) of a communication state. As an example of collision between a transmission resource and a reception resource in the time domain, as illustrated in FIG. 22, a PSFCH associated with a PSSCH reserved from the terminal 20B and a PSFCH associated with a PSSCH reserved from the terminal 20A may overlap at the terminal 20A.

Terminal-to-terminal coordination is being studied as a method to improve reliability and delay performance. For example, the terminal-to-terminal coordination method 1 and the terminal-to-terminal coordination method 2 illustrated below are being studied. Hereinafter, the terminal 20 transmitting coordination information is described as UE-A, and the terminal 20 receiving the coordination information is described as UE-B.

### Terminal-to-Terminal Coordination Method 1)

A preferred resource set and/or a non-preferred resource set is transmitted from a UE-A to a UE-B for transmission by the UE-B.

### Terminal-to-Terminal Coordination Method 2)

The UE-A transmits to the UE-B the fact that collision with another transmission or reception is expected, the possibility of collision or the fact that collision has been detected in the resource indicated by the SCI received from the UE-B. The “resource set” may be replaced by the fact.

Also, for example, methods relating to 1) to 6) shown below may be determined for terminal-to-terminal coordination.
1) When and how the terminal 20A determines the content of the resource set. UL scheduling may be considered.
2) When the terminal 20A notifies the terminal 20B of the resource set, and which terminal 20 notifies the resource set.
3) How the terminal 20 determines which terminal 20 notifies which terminal 20 of the resource set.
4) How the terminal 20A notifies the resource set. How to notify, either explicitly or implicitly.
5) When and how the terminal 20B receives or does not receive the resource set. And when and how the terminal 20B reflects or does not reflect the received resource set in the resource selection for transmission.
6) How to define or not define the linkage between support and signaling of terminal-to-terminal coordination, and the cast type.

In the terminal-to-terminal coordination method 1) described above, the UE-B may perform operations as illustrated in 1) to 4) below.
1) Resources of the UE-B used for resource selection or resource reselection for transmission may be determined based on both the UE-B sensing result and the coordination information received from the UE-A. It may be limited to the case where the UE-B's sensing result is available, and when the UE-B's sensing result is unavailable, the resources may be determined based only on the coordination information received from the UE-A.
2) Resources of the UE-B used for resource selection or resource reselection for transmission may be determined based only on the coordination information received from the UE-A.
3) Resources of the UE-B to be reselected may be determined based on the coordination information received from the UE-A.
4) Resources of the UE-B used for resource selection or resource reselection for transmission may be determined based on the coordination information received from the UE-A.

In the terminal-to-terminal coordination method 2), the UE-B may perform operations as illustrated in 1) to 2) below.
1) The UE-B may determine a resource to be reselected based on the coordination information received from the UE-A.
2) The UE-B may determine whether retransmission is necessary based on the coordination information received from the UE-A.

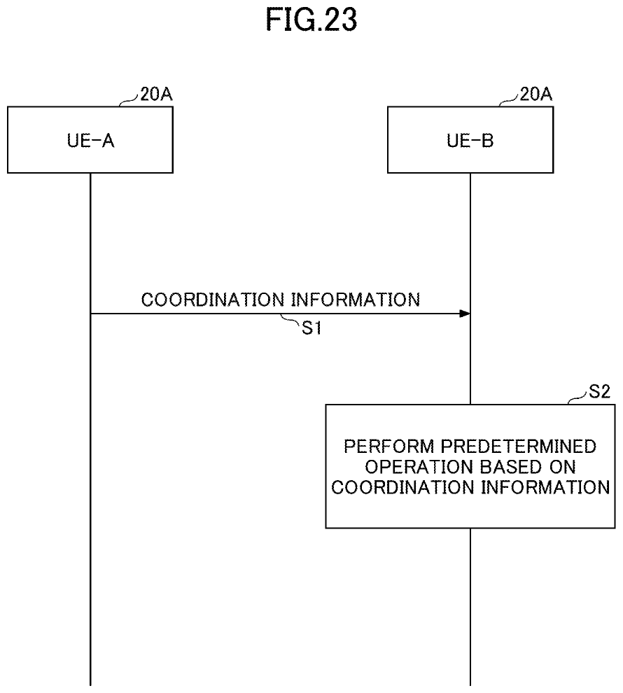

FIG. 23 is a sequence diagram illustrating an example of UE-to-UE coordination in an embodiment of the present invention. In step S1, the UE-A transmits coordination information to the UE-B. In step S2, the UE-B performs a predetermined operation based on the coordination information.

Here, in the terminal-to-terminal coordination method 2), it is considered that a notification, such as a PSFCH, relating to the coordination information is transmitted. For example, if the UE-A receives information relating to transmission or reservation of the UE-B and detects a collision with any signal based on that information, the UE-A may transmit, to the UE-B, information for notifying of the collision and/or information for notifying that resource reselection or retransmission should be performed via a channel similar to PSFCH. Hereinafter, the channel similar to PSFCH that transmits the information is referred to as PSCICH (Physical Sidelink Collision Indication Channel), but it may be referred to as PSFCH, and the channel similar to PSFCH that transmits the information is not limited to these.

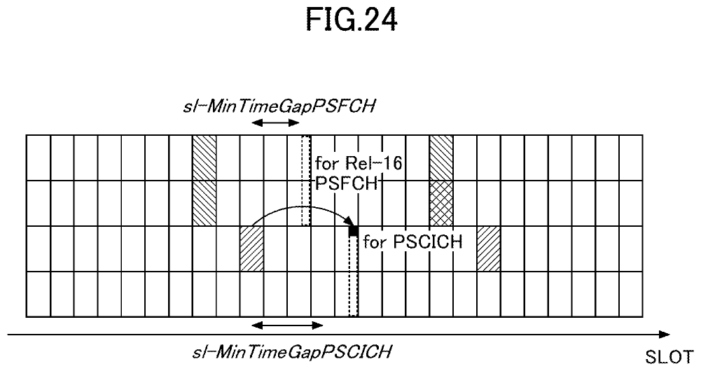

FIG. 24 is a diagram illustrating an example (1) of UE-to-UE coordination according to an embodiment of the present invention. As illustrated in FIG. 24, based on a resource of a signal received from the UE-B, the UE-A may determine a resource of a PSCICH. That is, the operation may be similar to that of the release 16 PSFCH. As illustrated in FIG. 24, the minimum gap from the received signal to the PSFCH may be specified by a parameter sl-MinTimeGapPSFCH. Also, as illustrated in FIG. 24, the minimum gap from the received signal to PSFCICH may be specified by a parameter sl-MinTimeGapPSCICH.

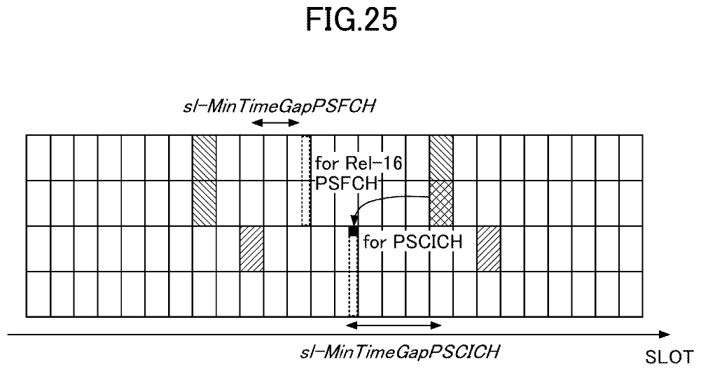

FIG. 25 is a diagram illustrating an example (2) of UE-to-UE coordination according to an embodiment of the present invention. As illustrated in FIG. 25, the UE-A may determine a resource of a PSCICH based on a resource that a signal received from the UE-B reserves. That is, the operation may be different from that of release 16 PSFCH. As illustrated in FIG. 25, the minimum gap from the resource that the received signal reserves to the PSCICH may be specified by a parameter sl-MinTimeGapPSCICH.

Here, in the terminal-to-terminal coordination method 2) described above, when the UE-A determines the resource of the PSCICH based on the resource that the signal received from the UE-B reserves, it is necessary to specify the operation when two or more resources are reserved by the UE-B. For example, it is necessary to specify that the PSCICH resource is determined based on which of the reserved resources. Also, operations of the UE-B receiving the PSCICH for the reserved multiple resources need to be specified. There is also a need to specify operations corresponding to a case in which non-periodic reservation, i.e., reservation using a time resource assignment field is used, and to a case in which periodic reservation, i.e., reservation using a resource reservation period field is used.

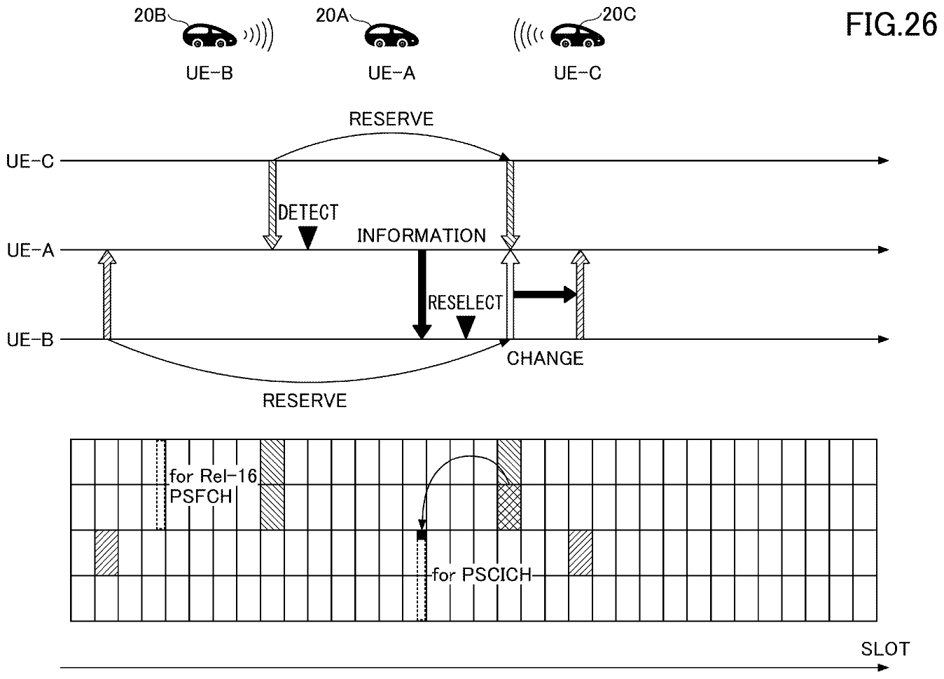

FIG. 26 is a diagram illustrating an example (3) of UE-to-UE coordination according to an embodiment of the present invention. As illustrated in FIG. 26, the UE-B has transmission data for the UE-A and makes resource reservation for transmission. Subsequently, the UE-A receives the resource reservation and a collision is expected to occur in the reserved resource. FIG. 26 is an example of a collision with a PSSCH transmitting resource of the UE-C in the reserved resource. Subsequently, the UE-A transmits a signal relating to collision prediction to the UE-B. Subsequently, after receiving the signal relating to the collision prediction, the UE-B stops using the reserved resource and performs resource reselection. Subsequently, the UE-B transmits the transmission data to the UE-A with the reselected resource.

As a condition relating to collision detection, the UE-A may be limited to a terminal 20 that is a destination of a transport block of the UE-B. The UE-A may be a terminal 20 indicated by a UE-ID associated with signal transmission of the UE-B. The UE-ID may be an ID at layer 1 or an ID at layer 2. Note that the “being destination of transport block” may be replaced by “intended by the UE-B”.

For a reservation signal for different transport block transmission transmitted from the UE-B, it may be assumed that the reserved resource is used for transmission to the same destination UE-A. For example, the reservation signal may be a reservation by a resource reservation period field.

In addition, when there are two or more destinations of the signal transmitted from the UE-B, all of the terminals 20 of the destinations may be UE-A, or some (a part) of the terminals 20 of the destinations may be UE-A. For example, the case where the signal is destined for two or more destinations may be the case where the signal transmitted by the UE-B is broadcast or groupcast. Among the terminals 20 of the destinations, the terminal 20 located within the communication range requirement may be the UE-A.

Among the terminals 20 of the two or more destinations, the terminal 20 of which received RSRP of the signal transmitted from the UE-B is equal to or greater than a predetermined value may be the UE-A, and the terminal 20 of which the received RSRP of the signal transmitted from the UE-B is equal to or less than a predetermined value may be the UE-A. Among the terminals of the two or more destinations, when the terminal 20 of which the received RSRP of the signal transmitted from the UE-B is equal to or greater than a predetermined value is the UE-A, the terminal 20 may be operated to improve the quality of the terminal 20 to which more data is to be delivered. Among the terminals 20 of the plurality of destinations, when the terminal 20 of which the received RSRP of the signal transmitted from the UE-B is equal to or less than a predetermined value is the UE-A, information that the UE-B cannot detect can be easily shared.

At the time of collision detection by the UE-A, when a reservation signal of the UE-B reserves two or more resources using a time resource assignment field, the UE-A may transmit a PSCICH to the UE-B in any of the methods 1-1, 1-2, 1-3, and 1-4 noted below. The reservation signal of the UE-B may notify of one transmission resource and two reserved resources.

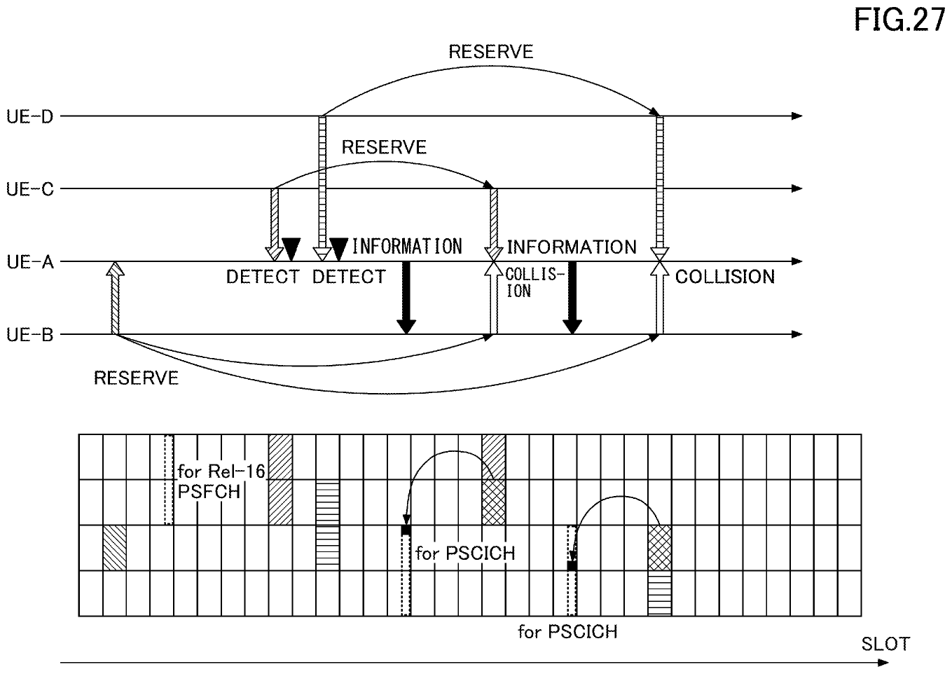

Method 1-1) The UE-A may transmit a PSCICH for each resource, in reserved resources of the UE-B, for which a collision is detected. FIG. 27 is a diagram illustrating an example (4) of UE-to-UE coordination according to an embodiment of the present invention. FIG. 27 illustrates the case in which a collision is detected in both the two reserved resources of the UE-A. As illustrated in FIG. 27, a PSCICH may be transmitted for a resource for which a collision between a reserved resource of the UE-B and a reserved resource of the UE-C is detected, and a PSCICH may be transmitted for a resource for which a collision between a reserved resource of the UE-B and a reserved resource of the UE-D is detected. That is, the terminal 20 may not transmit a PSCICH for resources for which no collision has been detected.

Further, for example, transmission of PSCICH may be limited for resources, among reserved resources, for which PSCICH can be transmitted, and whether or not PSCICH can be transmitted may mean whether or not the processing time of the UE involved in the transmission can be secured and/or whether or not the processing time for the UE-B to perform corresponding operation after receipt of PSCICH can be secured. The same applies to the following methods.

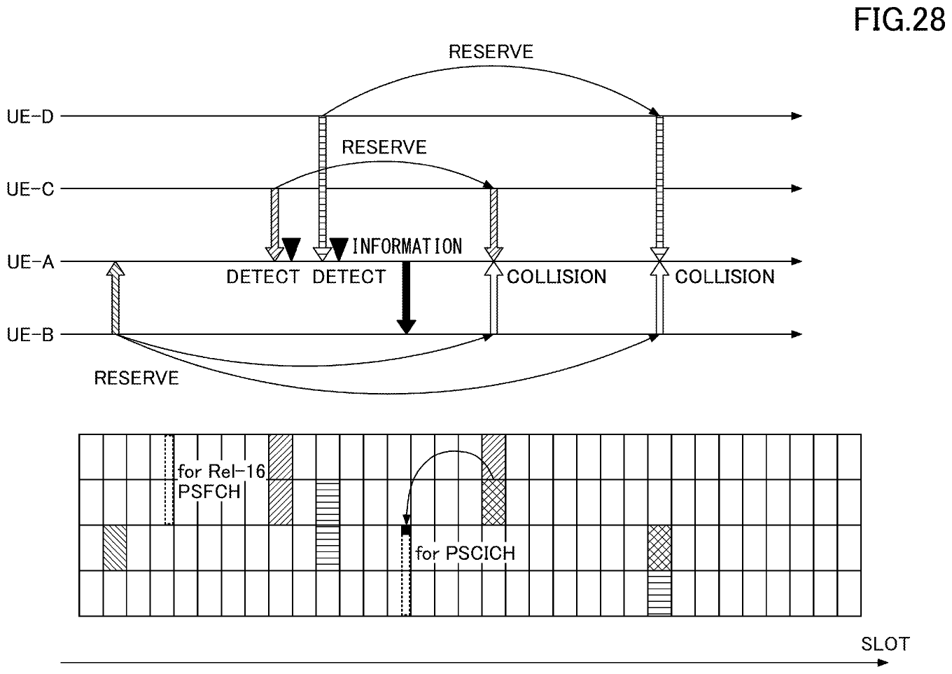

Method 1-2) The UE-A may transmit a PSCICH for a resource, in the reserved resources of the UE-B, for which a collision is detected. FIG. 28 is a diagram illustrating an example (5) of UE-to-UE coordination according to an embodiment of the present invention. FIG. 28 illustrates the case in which a collision is detected in both the two reserved resources of the UE-A. For example, as illustrated in FIG. 28, the terminal 20 may transmit a PSCICH for the earliest resource in the time domain, among resources for which a collision is detected, for which PSCICH transmission is available.

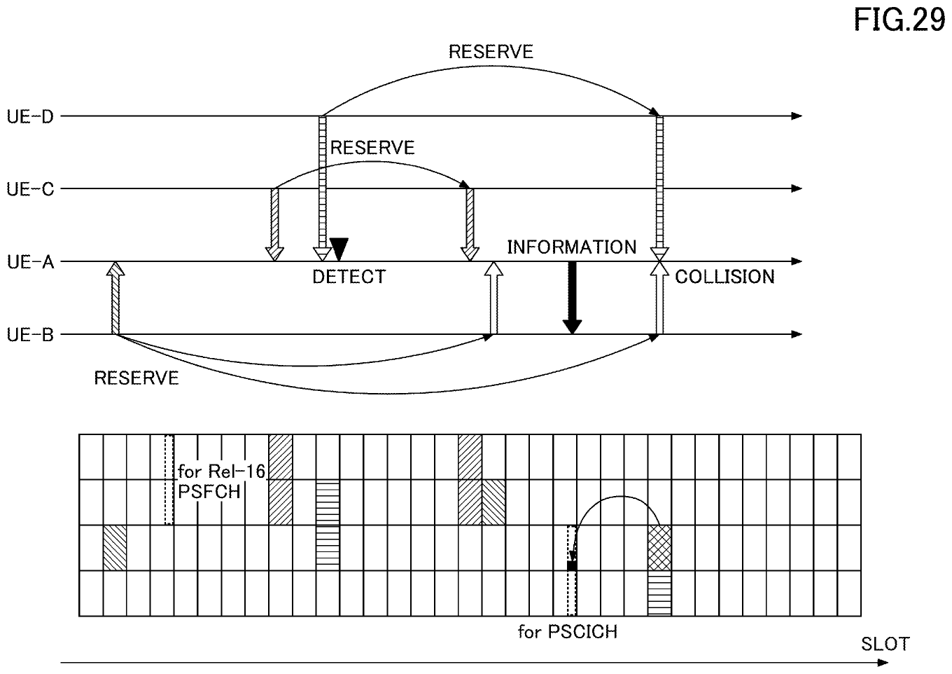

FIG. 29 is a diagram illustrating an example (6) of UE-to-UE coordination according to an embodiment of the present invention. FIG. 29 illustrates the case where a collision is detected only in the second one of the reserved resources of the UE-A. As illustrated in FIG. 29, the terminal 20 may transmit a PSCICH for the second resource for which a collision is detected.

For example, different PSCICH resources may be used based on which reserved resources are in collision. Alternatively, for example, different information may be transmitted based on which reserved resources are in collision.

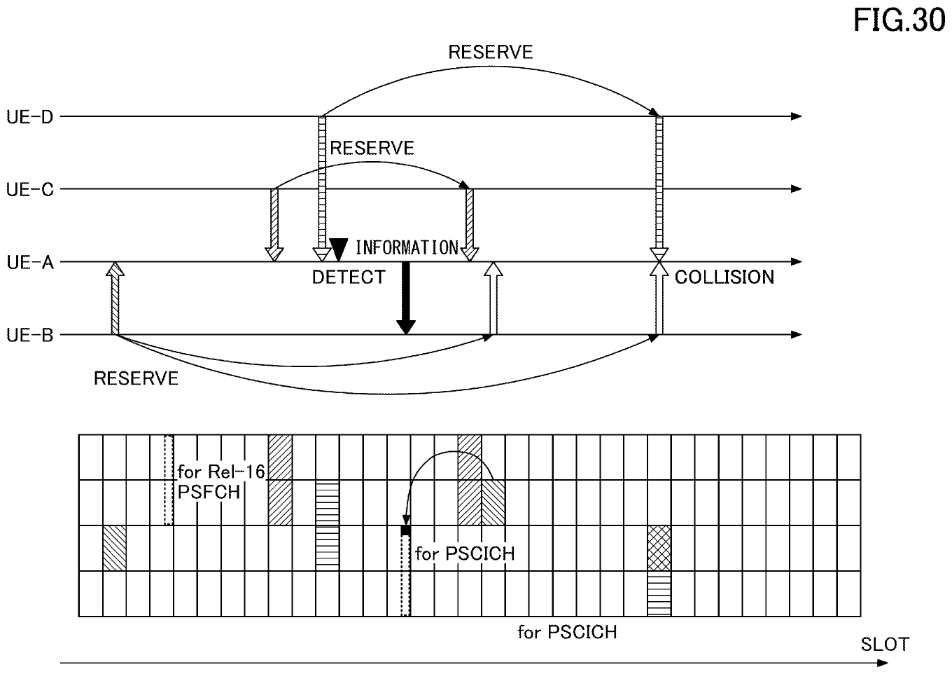

Method 1-3) The UE-A may transmit a PSCICH for any one of the reserved resources of the UE-B, regardless of whether a collision is detected or no collision is detected. FIG. 30 is a diagram illustrating an example (7) of UE-to-UE coordination according to an embodiment of the present invention. FIG. 30 illustrates the case where a collision is detected only in the second one of the reserved resources of the UE-A. For example, as illustrated in FIG. 30, the terminal 20 may transmit a PSCICH for the earliest resource in the time domain, among reserved resources, for which PSCICH transmission is available. As illustrated in FIG. 30, the terminal 20 may transmit a PSCICH at a time corresponding to the first one of the reserved resources for which no collision is detected.

Method 1-4) The UE-A may transmit a PSCICH for all the reserved resources of the UE-B. For example, the terminal 20 may transmit a PSCICH for the earliest resource in the time domain, among reserved resources, for which PSCICH transmission is available. That is, even if no collision is detected in a reserved resource, the terminal 20 may transmit a corresponding PSCICH.

For example, if the UE-A receives another reservation signal from the UE-B, the UE-A does not have to transmit a PSCICH for the reservation signal already received. Also, if the UE-A receives another reservation signal from the UE-B and the destination of the other reservation signal is the same as that of the already received reservation signal, the UE-A need not transmit a PSCICH for the already received reservation signal.

In Methods 1-1), 1-2), 1-3) and 1-4) described above, the PSCICH resource may be a time resource that goes back from the reserved resource by a predetermined time, and the predetermined time going back from the reserved resource may be determined based on a parameter. The parameter may, for example, be sl-MinTimeGapPSCICH. The UE-A may transmit a PSCICH in the first slot of a plurality of slots including PSCICH determined by sl-MinTimeGapPSCICH among slots in the resource pool prior to the PSSCH resource reserved by the UE-B in which resource collision is detected. The procedure for determining frequency resources and/or code resources of the PSCICH may be similar to that of PSFCH.

By transmitting coordination information through PSCICH as described above, resources can be clarified for transmitting a corresponding signal upon resource collision detection. Method 1-1) enables UE-B to recognize in which reserved resource collision detection is occurring, thus avoiding unnecessary re-selection of resources. Methods 1-2) and 1-3) enable UE-B to recognize resource collision as soon as possible to reduce latency performance. Method 1-4) can improve reliability of notification of coordination information for resource collision detection.

When the UE-A detects collision and UE-B's reservation signal reserves a resource at period P using a resource reservation period field, the UE-A may transmit a PSCICH to the UE-B by any of the methods illustrated below: Method 2-1), Method 2-2), Method 2-3), and Method 2-4). The UE-B's reservation signal may reserve two or more resources.

Method 2-1) The UE-A may transmit a PSCICH for each reserved resource in the period P for which a collision has been detected. For example, the UE-A may not send a PSCICH to a resource for which a collision has not been detected.

Method 2-2) The UE-A may transmit a PSCICH for a resource of resources in which a collision has been detected among the reserved resources of the period P. For example, the UE-A may transmit a PSCICH for the earliest resource in the time domain that can transmit the PSCICH. Also, for example, the UE-A may use a different PSCICH resource based on which reserved resources are in collision. Also, for example, UE-A may transmit different information via the PSCICH based on which reserved resources are in collision.

Method 2-3) The UE-A may transmit a PSCICH for a resource among the reserved resources of the period P. For example, the UE-A may transmit a PSCICH corresponding the earliest resource in the time domain that can transmit a PSCICH. Also, for example, UE-A may transmit a PSCICH corresponding to a reserved resource for which no collision has been detected.

Method 2-4) The UE-A may transmit a PSCICH for all the reserved resources of the period P. For example, the UE-A may transmit a PSCICH corresponding to a reserved resource for which no collision has been detected. Also, for example, if the UE-A receives another reservation signal from the UE-B, the UE-A does not need to transmit a PSCICH for the previously received reservation signal. Also, for example, if the UE-A receives another reservation signal from the UE-B and the destination of the other reservation signal is the same as that of the previously received reservation signal, the UE-A need not transmit a PSCICH for the previously received reservation signal.

By transmitting coordination information through a PSCICH as described above, resources can be clarified for transmitting a corresponding signal upon resource collision detection. Method 2-1) enables the UE-B to recognize in which reserved resource collision detection is occurring, thus avoiding unnecessary re-selection of resources. Methods 2-2) and 2-3) enable the UE-B to recognize resource collision as soon as possible to reduce latency performance. Method 2-4) can improve the reliability of notification of coordination information for resource collision detection.

In Method 1-1), Method 1-2), Method 1-3), Method 1-4), Method 2-1), Method 2-2), Method 2-3) and Method 2-4), the UE-B that receives a PSCICH from the UE-A may perform any of the following operations: Method 3-1), Method 3-2), Method 3-3) and Method 3-4), if SCI that reserves a reserved resource corresponding to the PSCICH reserves two or more resources.

Method 3-1) the UE-B may not use the reserved resource corresponding to the PSCICH, or may perform reselection of resources for the reserved resource. For example, the UE-B may not perform reselection of resources other than the reserved resource corresponding to the PSCICH.

For example, the reserved resource to which the operation illustrated in Method 3-1) is applied may be limited to a reserved resource that can secure processing time for the UE-B to stop using resources or to reselect resources, after receiving the PSCICH. The same applies to the following methods.

Method 3-2) The UE-B may not use all reserved resources reserved by the SCI that reserved the reserved resource corresponding to the PSCICH, or may perform resource reselection for all reserved resources.

Method 3-3) The UE-B may not use the reserved resource indicated by the PSCICH, or may perform resource reselection for the reserved resource.

Method 3-4) The UE-B may not use the reserved resource indicated by the PSCICH and subsequent reserved resources, or may perform resource reselection for the reserved resources.

By performing the operations illustrated in Methods 3-1), 3-2), 3-3), and 3-4) described above, the UE-B can avoid resource collision based on the notification of coordination information from the UE-A.

The above-described embodiment may be applied to an operation in which a terminal 20 configures or allocates transmitting resources for another terminal 20.

The above described embodiments are not limited to V2X terminals, but may be applied to terminals that perform D2D communication.

The operations in accordance with the embodiments described above may be performed only in a particular resource pool. For example, the operations in accordance with the embodiments described above may be performed only in a resource pool that can be used by terminals 20 of release 17 or later releases.

In accordance with the above-described embodiments, when the terminal 20 receives information relating to terminal-to-terminal coordination from another terminal 20, the terminal 20 can select or re-select a resource based on the information. When the terminal 20 receives the information relating to the terminal-to-terminal coordination from the other terminal 20, the terminal 20 may determine whether or not to retransmit a transport block that is already transmitted based on the information.

That is, in the terminal-to-terminal direct communication, reliability of communication at the time of autonomous resource selection can be improved.

### (Apparatus Configuration)

Next, a functional configuration example of the base station 10 and the terminal 20 for performing the processes and operations described above will be described. The base station 10 and the terminal 20 include functions for implementing the embodiments described above. However, each of the base station 10 and the terminal 20 may include only some of the functions in the embodiments.

### <Base Station 10>

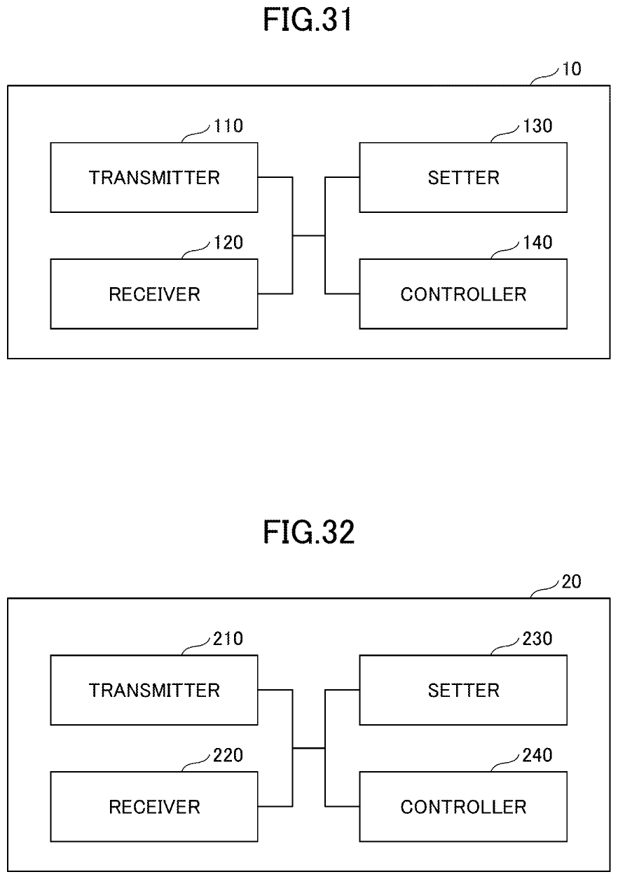

FIG. 31 is a diagram illustrating an example of a functional configuration of the base station 10. As illustrated in FIG. 31, the base station 10 includes a transmitter 110, a receiver 120, a setter 130, and a controller 140. The functional configuration illustrated in FIG. 31 is only one example. A functional category and the name of the functional unit may be any category or name insofar as the functional unit can perform the operations according to the embodiments of the present invention.

The transmitter 110 includes a function for generating a signal to be transmitted to the terminal 20 side and transmitting the signal wirelessly. The receiver 120 includes a function for receiving various signals transmitted from the terminal 20 and acquiring, for example, information relating to a higher layer from the received signals. The transmitter 110 has a function to transmit NR-PSS, NR-SSS, NR-PBCH, DL/UL control signals, DL reference signals, and the like to the terminal 20.

The setter 130 stores preconfigured configuration information and various configuration information to be transmitted to the terminal 20 in the storage device and reads the preconfigured configuration information from the storage device if necessary. The contents of the configuration information are, for example, information relating to configuration of D2D communication.

As described in the exemplary embodiment, the controller 140 performs processing relating to configuration in which the terminal 20 performs D2D communication. The controller 140 transmits scheduling of D2D communication and DL communication to the terminal 20 through the transmitter 110. The controller 140 receives information relating to HARQ response of the D2D communication and the DL communication from the terminal 20 via the receiver 120. A functional unit relating to signal transmission in the controller 140 may be included in the transmitter 110, and a functional unit relating to signal reception in the controller 140 may be included in the receiver 120.

### <Terminal 20>

FIG. 32 is a diagram illustrating an example of a functional configuration of the terminal 20. As illustrated in FIG. 32, the terminal 20 includes a transmitter 210, a receiver 220, a setter 230, and a controller 240. The functional configuration illustrated in FIG. 32 is only one example. A functional category and the name of the functional unit may be any category or name insofar as the functional unit can perform the operations according to the embodiments of the present invention.

The transmitter 210 generates a transmission signal from the transmission data and wirelessly transmits the transmission signal. The receiver 220 receives various signals wirelessly and acquires higher layer signals from the received signals of the physical layer. The receiver 220 has a function to receive NR-PSS, NR-SSS, NR-PBCH, DL/UL/SL control signals or reference signals transmitted from the base station 10. For example, the transmitter 210 transmits PSCCH (Physical Sidelink Control Channel), PSSCH (Physical Sidelink Shared Channel), PSDCH (Physical Sidelink Discovery Channel), PSBCH (Physical Sidelink Broadcast Channel), and the like to the other terminal 20 as D2D communication, and the receiver 220 receives PSCCH, PSSCH, PSDCH, PSBSH, or the like from the other terminal 20.

The setter 230 stores various configuration information received from the base station 10 or the terminal 20 via the receiver 220 in the storage device and reads the received configuration information from the storage device as necessary. The setter 230 also stores the preconfigured configuration information. The contents of the configuration information are, for example, information relating to configuration of D2D communication.

As described in the embodiment, the controller 240 controls D2D communication to establish an RRC connection with the other terminal 20. The controller 240 performs processing relating to the power saving operation. The controller 240 performs processing relating to HARQ of D2D communication and DL communication. The controller 240 transmits, to the base station, information relating to the HARQ response of the D2D communication and the DL communication to the other terminal 20 scheduled from the base station 10. The controller 240 may schedule D2D communication to the other terminal 20. The controller 240 may select resources used for D2D communication autonomously from the resource selection window based on the sensing result, or may perform reevaluation or preemption. The controller 240 performs processing relating to power saving when transmitting and receiving D2D communication. The controller 240 performs processing relating to terminal-to-terminal coordination in D2D communication. A functional unit relating to signal transmission in the controller 240 may be included in the transmitter 210, and a functional unit relating to signal reception in the controller 240 may be included in the receiver 220.

### (Hardware Configuration)

The block diagrams (FIG. 31 and FIG. 32) used for the description of the above embodiments illustrate blocks of functional units. These functional blocks (components) are implemented by any combination of at least one of hardware and software. In addition, the implementation method of each functional block is not particularly limited. That is, each functional block may be implemented using a single device that is physically or logically combined, or may be implemented by directly or indirectly connecting two or more devices that are physically or logically separated (e.g., using wire, radio, etc.) and using these multiple devices. The functional block may be implemented by combining software with the above-described one device or the above-described plurality of devices.

Functions include, but are not limited to, judgment, decision, determination, computation, calculation, processing, derivation, research, search, verification, reception, transmission, output, access, resolution, choice, selection, establishment, comparison, assumption, expectation, deeming, broadcasting, notifying, communicating, forwarding, configuring, reconfiguring, allocating, mapping, assigning, and the like. For example, a functional block (component) that functions to transmit is called a transmitting unit or a transmitter. In either case, as described above, the implementation method is not particularly limited.

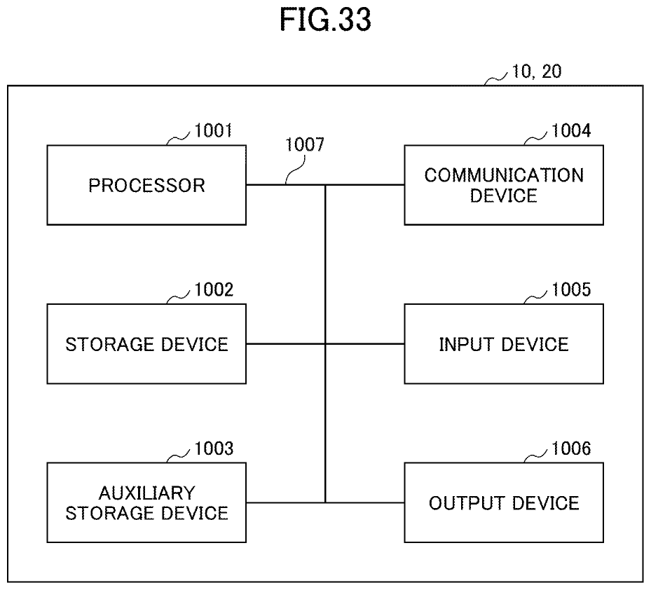

For example, the base station 10, the terminal 20, or the like in an embodiment of the present disclosure may function as a computer for performing a process of the radio communication method according to the present disclosure. FIG. 33 is a diagram illustrating an example of a hardware configuration of the base station 10 and the terminal 20 according to an embodiment of the present disclosure. Each of the base station 10 and the terminal 20 described above may be physically configured as a computer device including a processor 1001, a storage device 1002, an auxiliary storage device 1003, a communication device 1004, an input device 1005, an output device 1006, a bus 1007, and the like.

In the following description, the term “device” can be replaced with a circuit, device, unit, or the like. The hardware configuration of each of the base station 10 and the terminal 20 may be configured to include each device depicted, or may be configured without including some devices.

Each function in each of the base station 10 and the terminal 20 is implemented such that predetermined software (program) is read on hardware, such as the processor 1001, the storage device 1002, and the like, and the processor 1001 performs an operation and controls communication by the communication device 1004 and at least one of reading and writing of data in the storage device 1002 and the auxiliary storage device 1003.

For example, the processor 1001 operates an operating system and controls the entire computer. The processor 1001 may be configured with a Central Processing Unit (CPU) including an interface with a peripheral device, a control device, an operation device, a register, and the like. For example, the above-described controller 140, the controller 240, and the like may be implemented by the processor 1001.

Furthermore, the processor 1001 reads a program (program code), a software module, data, or the like from at least one of the auxiliary storage device 1003 and the communication device 1004 out to the storage device 1002, and executes various types of processes according to them. A program causing a computer to execute at least some of the operations described in the above embodiments is used as the program. For example, the controller 140 of the base station 10 illustrated in FIG. 31 may be implemented by a control program which is stored in the storage device 1002 and operates on the processor 1001. Furthermore, for example, the controller 240 of the terminal 20 illustrated in FIG. 32 may be implemented by a control program which is stored in the storage device 1002 and operates on the processor 1001. Various types of processes are described to be executed by one processor 1001 but may be executed simultaneously or sequentially by two or more processors 1001. The processor 1001 may be implemented by one or more chips. The program may be transmitted from a network via an electric communication line.

The storage device 1002 is a computer readable recording medium and may be configured with, for example, at least one of a Read Only Memory (ROM), an Erasable Programmable ROM (EPROM), an Electrically Erasable Programmable ROM (EEPROM), a Random Access Memory (RAN), and the like. The storage device 1002 may also be referred to as a “register,” a “cache,” a “main memory,” or the like. The storage device 1002 can store programs (program codes), software modules, or the like which are executable for carrying out the communication method according to an embodiment of the present disclosure.

The auxiliary storage device 1003 is a computer-readable recording medium and may be configured with, for example, at least one of an optical disk such as a Compact Disc ROM (CD-ROM), a hard disk drive, a flexible disk, a magneto-optical disk (for example, a compact disk, a digital versatile disk, or a Blu-ray (registered trademark) disc), a smart card, a flash memory (for example, a card, a stick, or a key drive), a floppy (registered trademark) disk, a magnetic strip, and the like. The above-described storage medium may be, for example, a database, a server, or any other appropriate medium including at least one of the storage device 1002 and the auxiliary storage device 1003.

The communication device 1004 is hardware (a transmitting and receiving device) for performing communication between computers via at least one of a wired network and a wireless network and is also referred to as, for example, a “network device,” a “network controller,” a “network card,” a “communication module,” or the like. The communication device 1004 may be configured to include a high frequency switch, a duplexer, a filter, a frequency synthesizer, and the like to implement at least one of frequency division duplex (FDD: Frequency Division Duplex) and time division duplex (TDD: Time Division Duplex). For example, transmitting and receiving antennas, an amplifier, a transceiver, a transmission line interface, and the like may be implemented by the communication device 1004. The transceiver may be implemented such that a transmitter and a receiver are physically or logically separated.

The input device 1005 is an input device configured to receive an input from the outside (such as a keyboard, a mouse, a microphone, a switch, a button, a sensor, or the like). The output device 1006 is an output device that performs an output to the outside (for example, a display, a speaker, an LED lamp, or the like). The input device 1005 and the output device 1006 may be integrally formed (such as a touch panel).

The devices, such as the processor 1001 and the storage device 1002, are connected by the bus 1007 for communicating information. The bus 1007 may be configured with a single bus or may be configured with different buses between the devices.

Furthermore, each of the base station 10 and the terminal 20 may be configured to include hardware, such as a microprocessor, a digital signal processor (DSP: Digital Signal Processor), an Application Specific Integrated Circuit (ASIC), a Programmable Logic Device (PLD), or a Field Programmable Gate Array (FPGA), or all or some of the functional blocks may be implemented by the hardware. For example, the processor 1001 may be implemented by at least one of these hardware components.

### Summary of Embodiments

As described above, according to an embodiment of the present invention, a terminal is provided. The terminal includes
a receiver configured to receive a signal from a first terminal and a second terminal in a resource pool;
a controller configured to detect overlap between a first reserved resource based on a signal received from the first terminal and a second reserved resource based on a signal received from the second terminal; and
a transmitter configured to transmit information relating to resource selection to the first terminal via a collision notification channel, in response to the controller detecting the overlap, wherein
when the first reserved resource includes a plurality of resources, the controller determines which collision notification channel associated with a resource of the plurality of resources to use for transmitting information relating to the resource selection.

With the above configuration, the terminal 20 may select or re-select a resource based on the information relating to terminal-to-terminal coordination received from the other terminal 20. When the terminal 20 receives the information relating to terminal-to-terminal coordination from the other terminal 20, the terminal 20 may determine whether or not to retransmit the transmitted transport block based on the information. That is, in the terminal-to-terminal direct communication, the reliability of the communication at the time of autonomous resource selection can be improved.

The controller may determine to transmit information relating to the resource selection via a collision notification channel associated with each of all resources in which the overlap has been detected from among the plurality of resources. This configuration enables the terminal 20 to select or re-select a resource based on the information relating to terminal-to-terminal coordination received from the other terminal 20. When the terminal 20 receives the information relating to the terminal-to-terminal coordination from the other terminal 20, the terminal 20 may determine whether or not to retransmit the transmitted transport block based on the information.

The controller may determine to transmit information relating to the resource selection via a collision notification channel associated with any one of the plurality of resources in which the overlap has been detected. This configuration enables the terminal 20 to select or re-select a resource based on the information relating to terminal-to-terminal coordination received from the other terminal 20. When the terminal 20 receives the information relating to the terminal-to-terminal coordination from the other terminal 20, the terminal 20 may determine whether or not to retransmit the transmitted transport block based on the information.

The controller may determine to transmit information relating to the resource selection via a collision notification channel associated with a resource that is the earliest in the time domain, from among the plurality of resources from which the overlap has been detected. This configuration enables the terminal 20 to select or re-select a resource based on the information relating to terminal-to-terminal coordination received from the other terminal 20. When the terminal 20 receives the information relating to the terminal-to-terminal coordination from the other terminal 20, the terminal 20 may determine whether or not to retransmit the transmitted transport block based on the information.

The controller may determine to transmit information relating to the resource selection via a collision notification channel associated with a resource that is the earliest in the time domain, from among the plurality of resources. This configuration enables the terminal 20 to select or re-select a resource based on the information relating to terminal-to-terminal coordination received from the other terminal 20. When the terminal 20 receives the information relating to the terminal-to-terminal coordination from the other terminal 20, the terminal 20 may determine whether or not to retransmit the transport block transmitted based on the information.

In addition, according to another embodiment of the present invention, a communication method which is performed by a terminal is provided. The communication method includes:
receiving signals from a first terminal and a second terminal in a resource pool;
detecting overlap between a first reserved resource based on a signal received from the first terminal and a second reserved resource based on a signal received from the second terminal; and
transmitting information relating to resource selection to the first terminal via a collision notification channel, when the overlap is detected,
wherein
when the first reserved resource includes a plurality of resources, the terminal determines which collision notification channel associated with a resource of the plurality of resources to use for transmitting information relating to the resource selection.

The above configuration enables the terminal 20 to select or re-select a resource based on the information relating to terminal-to-terminal coordination received from the other terminal 20. When the terminal 20 receives the information relating to the terminal-to-terminal coordination from the other terminal 20, the terminal 20 may determine whether or not to retransmit the transmitted transport block based on the information. That is, in the terminal-to-terminal direct communication, the reliability of the communication at the time of autonomous resource selection can be improved.

### Supplement to Embodiment

The exemplary embodiment of the present invention has been described above, but the disclosed invention is not limited to the above embodiments, and those skilled in the art would identify various modified examples, revised examples, alternative examples, substitution examples, and the like. In order to facilitate identifying of the invention, specific numerical value examples have been used for description, but the numerical values are merely examples, and certain suitable values may be used unless otherwise stated. The classification of items in the above description is not essential to the present invention. Matters described in two or more items may be combined and used if necessary, and a matter described in one item may be applied to a matter described in another item (as long as there is no contradiction). The boundary between functional units or processing units in a functional block diagram does not necessarily correspond to the boundary between physical parts. Operations of a plurality of functional units may be performed physically by one component, or an operation of one functional unit may be physically performed by a plurality of parts. In the processing step described in the embodiments, the order of the processes may be changed as long as there is no contradiction. For the sake of convenience of processing description, the base station 10 and the terminal 20 are described using the functional block diagrams, but such devices may be implemented by hardware, software, or a combination thereof. Software executed by the processor included in the base station 10 according to the embodiment of the present invention and software executed by the processor included in the terminal 20 according to the embodiment of the present invention may be stored in a random access memory (RAM), a flash memory, a read-only memory (ROM), an EPROM, an EEPROM, a register, a hard disk (HDD), a removable disk, a CD-ROM, a database, a server, or any other appropriate storage medium.

Furthermore, a notification of information is not limited to the aspect or embodiment described in the present disclosure and may be provided by using any other method. For example, the notification of information may be provided by physical layer signaling (for example, Downlink Control Information (DCI) or Uplink Control Information (UCI)), higher layer signaling (for example, Radio Resource Control (RRC) signaling, Medium Access Control (MAC) signaling, broadcast information (Master Information Block (MIB), System Information Block (SIB)), other signals, or a combination thereof. Furthermore, the RRC signaling may be referred to as an RRC message and may be, for example, an RRC Connection Setup message, an RRC Connection Reconfiguration message, or the like.

Each aspect and embodiment described in the present disclosure may be applied to at least one of Long Term Evolution (LTE), LTE-advanced (LTE-A), SUPER 3G, IMT-advanced, 4th generation mobile communication system (4G), 5th generation mobile communication system (5G), Future Radio Access (FRA), new Radio (NR), W-CDMA (registered trademark), GSM (registered trademark), CDMA 2000, Ultra Mobile Broadband (UMB), IEEE 802.11 (Wi-Fi (registered trademark)), IEEE 802.16 (WiMAX(registered trademark)), IEEE 802.20, Ultra-WideBand (UWB), Bluetooth (registered trademark), a system using any other appropriate system, and next generation systems extended based on these standards. Furthermore, a plurality of systems (e.g., a combination of at least one of LTE and LTE-A with 5G) may be combined to be applied.

The order of the processing steps, the order of the sequences, the order of the flowcharts, and the like of the respective aspects/embodiments described in this specification may be changed, provided that there is no contradiction. For example, the method described in the present disclosure presents elements of various steps with an exemplary order and is not limited to a presented specific order.

In this specification, a specific operation to be performed by the base station 10 may be performed by an upper node in some cases. In the network including one or more network nodes including the base station 10, various operations performed for communication with the terminal 20 can be obviously performed by at least one of the base station 10 and any network node (for example, an MME, an S-GW, or the like is considered, but it is not limited thereto) other than the base station 10. A case is exemplified above in which there is one network node other than the base station 10. The one network node may be a combination of a plurality of other network nodes (e.g., MME and S-GW).

Information, a signal, or the like described in the present disclosure may be output from a higher layer (or a lower layer) to a lower layer (or a higher layer layer). Information, a signal, or the like described in the present disclosure may be input and output via a plurality of network nodes.

Input and output information and the like may be stored in a specific place (for example, a memory) or may be managed by using a management table. Input and output information and the like may be overwritten, updated, or additionally written. Output information and the like may be deleted. Input information and the like may be transmitted to another device.

The determination in the present disclosure may be made in accordance with a value (0 or 1) indicated by one bit, may be made in accordance with a Boolean value (Boolean: true or false), or may be made by a comparison of numerical values (for example, a comparison with a predetermined value).

Software should be broadly interpreted to mean a command, a command set, a code, a code segment, a program code, a program, a subprogram, a software module, an application, a software application, a software package, a routine, a subroutine, an object, an executable file, an execution thread, a step, a function, and the like regardless of whether software is called software, firmware, middleware, a microcode, a hardware description language, or any other name.

Furthermore, software, commands, information, and the like may be transmitted and received via a transmission medium. For example, when software is transmitted from a web site, a server, or any other remote source using a wired technology (such as a coaxial cable, a fiber optic cable, a twisted pair, or a digital subscriber line (DSL: Digital Subscriber Line)) and a radio technology (such as infrared rays or a microwave), at least one of the wired technology and the radio technology is included in a definition of a transmission medium.

Information, signals, and the like described in the present disclosure may be expressed using any one of a variety of different technologies. For example, data, instructions, commands, information, signals, bits, symbols, chips, and the like which are mentioned throughout the above description may be expressed by voltages, currents, electromagnetic waves, magnetic fields or magnetic particles, optical fields or photons, or any combination thereof.

The terms described in the present disclosure and terms necessary for understanding the present disclosure may be replaced with terms having the same or similar meanings. For example, at least one of a channel and a symbol may be a signal (signaling). Furthermore, a signal may be a message. Furthermore, a component carrier (CC: Component Carrier) may be referred to as a “carrier frequency,” a “cell,” a “frequency carrier,” or the like.

The terms “system” and “network” used in the present disclosure are used interchangeably.

Furthermore, information, parameters, and the like described in the present disclosure may be expressed by using absolute values, may be expressed by using relative values from predetermined values, or may be expressed by using any other corresponding information. For example, radio resources may be those indicated by an index.

The names used for the above-described parameters are not limited names in any point of view. Furthermore, mathematical formulas or the like using the parameters may be different from those explicitly disclosed in the present disclosure. Since various channels (for example, a PUSCH, a PUCCH, a PDCCH, and the like) and information elements can be identified by any suitable names, various names assigned to the various channels and the information elements are not limited names in any point of view.

In the present disclosure, the terms “base station (BS: Base Station),” “radio base station,” “base station,” “fixed station,” “Node B,” “eNode B (eNB),” “gNodeB (gNB),” “access point,” “transmission point,” “reception point,” “transmission/reception point,” “cell,” “sector,” “cell group,” “carrier,” “component carrier,” and the like can be used interchangeably. The base station may also be referred to by a term, such as a macrocell, a small cell, a femtocell, and a picocell.

The base station can accommodate one or more (for example, three) cells. In a case in which the base station accommodates a plurality of cells, the entire coverage area of the base station can be partitioned into a plurality of small areas, and each small area can provide a communication service through a base station subsystem (for example, a small indoor base station (RRH: Remote Radio Head)). The term “cell” or “sector” refers to the whole or a part of the coverage area of at least one of the base station and the base station subsystem that performs a communication service in the coverage.

In the present disclosure, the terms “mobile station (MS: Mobile Station),” “user terminal,” “UE: User Equipment,” “terminal,” and the like can be used interchangeably.

The mobile station may be referred to, by a person ordinarily skilled in the art, as a subscriber station, a mobile unit, a subscriber unit, a wireless unit, a remote unit, a mobile device, a wireless device, a wireless communication device, a remote device, a mobile subscriber station, an access terminal, a mobile terminal, a terminal, a wireless terminal, a remote terminal, a handset, a user agent, a mobile client, a client, or some other suitable terms.

At least one of the base station and the mobile station may be also referred to as a transmitting device, a receiving device, a communication device, or the like. At least one of the base station and the mobile station may be a device installed in a mobile body, a mobile body itself, or the like. The mobile body may be a vehicle (for example, a car, an airplane, or the like), an unmanned body that moves (for example, a drone, an autonomous car or the like), or a robot (manned type or unmanned type). At least one of the base station and the mobile station includes a device that need not move during a communication operation. For example, at least one of the base station and the mobile station may be an Internet of Things (IoT) device such as a sensor.

Furthermore, the base station in the present disclosure may be replaced with a user terminal. For example, each aspect/embodiment of the present disclosure may be applied to a configuration in which communication between the base station and the terminal is replaced with communication between a plurality of terminals 20 (for example, which may be referred to as Device-to-Device (D2D) or Vehicle-to-Everything (V2X)). In this case, the terminal 20 may have the functions of the base station 10 described above. Furthermore, the terms “uplink” and “downlink” may be replaced with terms (for example, “side”) corresponding to terminal-to-terminal communication. For example, an uplink channel, a downlink channel, or the like may be replaced with side channels.

Similarly, the terminal in the present disclosure may be replaced with the base station. In this case, the base station may have the functions of the above-described terminal.

The terms “determination(determining)” and “decision (determining)” used in the present specification may include various types of operations. The “determination” and “decision” may include deeming “judging,” “calculating,” “computing,” “processing,” “deriving,” “investigating,” “looking up (for example, searching in a table, a database, or another data structure),” or “ascertaining” as “determining” and/or “deciding.” Furthermore, the “determination” and “decision” may include deeming “receiving (for example, receiving information),” “transmitting (for example, transmitting information),” “inputting,” “outputting,” or “accessing (for example, accessing data in a memory)” as “determining” and/or “deciding.” Furthermore, the “determination” and “decision” may include deeming “resolving,” “selecting,” “choosing,” “establishing,” or “comparing” as “determining” and/or “deciding.” Namely, the “determination” and “decision” may include deeming an operation as “determining” and/or “deciding.” Furthermore, “determining” may be replaced with “assuming,” “expecting,” “considering,” or the like.

Terms “connected,” “coupled,” or variations thereof means any direct or indirect connection or coupling between two or more elements and may include the presence of one or more intermediate elements between two elements which are “connected” or “coupled.” The coupling or the connection between the elements may be physical, logical, or a combination thereof. For example, “connection” may be replaced with “access.” In a case of using in the present disclosure, two elements may be considered to be “connected” or “coupled” with each other using at least one of one or more electric wires, cables and/or a printed electrical connection or using electromagnetic energy having a wavelength in a radio frequency domain, a microwave domain, or a light (both visible and invisible) domain as non-limiting and non-exhaustive examples.

A reference signal may be abbreviated as RS (Reference Signal) and may be referred to as a pilot, depending on a standard to be applied.

A phrase “based on” used in the present disclosure is not limited to “based only on” unless otherwise stated. In other words, a phrase “based on” means both “based only on” and “based on at least.”

Any reference to an element using a designation, such as “first” or “second,” used in the present disclosure does not generally restrict quantities or an order of those elements. Such designations can be used in the present disclosure as a convenient method of distinguishing two or more elements. Thus, reference to the first and second elements does not mean that only two elements can be adopted there, or the first element must precede the second element in a certain form.

Furthermore, “means” in the configuration of each of the above devices may be replaced with “unit,” “circuit,” “device,” or the like.

When “include,” “including,” and variations thereof are used in the present disclosure, these terms are intended to be comprehensive, similar to a term “provided with (comprising).” Furthermore, the term “or” used in the present disclosure is intended not to be an exclusive OR.

A radio frame may include one or more frames in the time domain. In the time domain, each of one or more frames may be referred to as a subframe. The subframe may further include one or more slots in the time domain. The subframe may have a fixed time length (for example, 1 ms) not depending on numerology.

The numerology may be a communication parameter applied to at least one of transmission and reception of a certain signal or channel. For example, the numerology may indicate at least one of a subcarrier spacing (SCS), a bandwidth, a symbol length, a cyclic prefix length, a transmission time interval (TTI: Transmission Time Interval), a number of symbols per TTI, a radio frame configuration, a specific filtering process performed in the frequency domain by a transceiver, a specific windowing process performed in the time domain by a transceiver, and the like.

The slot may include one or more symbols (Orthogonal Frequency Division Multiplexing (OFDM) symbols, Single Carrier Frequency Division Multiple Access (SC-FDMA) symbols, or the like) in the time domain. The slot may be a time unit based on the numerology.

The slot may include a plurality of mini slots. Each mini slot may include one or more symbols in the time domain. Furthermore, the mini slot may be referred to as a sub-slot. The mini slot may include fewer symbols than a slot. A PDSCH (or PUSCH) transmitted in a unit of time greater than a mini slot may be referred to as a PDSCH (or PUSCH) mapping type A. A PDSCH (or PUSCH) transmitted using a mini slot may be referred to as a PDSCH (or PUSCH) mapping type B.

Any one of a radio frame, a subframe, a slot, a mini slot, and a symbol indicates a time unit for transmitting a signal. As a radio frame, a subframe, a slot, a mini slot, and a symbol, different names corresponding to them may be used.

For example, one subframe may be referred to as a transmission time interval (TTI: Transmission Time Interval), or a plurality of consecutive subframes may be referred to as TTIs, or one slot or one mini slot may be referred to as a TTI. In other words, at least one of the subframe and the TTI may be a subframe (1 ms) in the existing LTE, may be a period shorter than 1 ms (for example, 1 to 13 symbols), or may be a period longer than 1 ms. A unit representing the TTI may be referred to as slot, a mini slot, or the like instead of the subframe.

Here, for example, the TTI refers to a minimum time unit of scheduling in radio communication. For example, in the LTE system, the base station performs scheduling of allocating a radio resource (a frequency bandwidth, a transmission power, or the like which can be used in each terminal 20) to each terminal 20 in units of TTIs. The definition of the TTI is not limited thereto.

The TTI may be a transmission time unit such as a channel coded data packet (transport block), a code block, or a code word, or may be a processing unit such as scheduling or link adaptation. Furthermore, when a TTI is provided, a time interval (for example, the number of symbols) in which a transport block, a code block, a code word, or the like is actually mapped may be shorter than the TTI.

When one slot or one mini slot is referred to as a TTI, one or more TTIs (that is, one or more slots or one or more mini slots) may be a minimum time unit of scheduling. Furthermore, the number of slots (the number of mini slots) forming the minimum time unit of scheduling may be controlled.

A TTI having a time length of 1 ms may be referred to as a common TTI (TTI in LTE Rel. 8 to 12), a normal TTI, a long TTI, a common subframe, a normal subframe, a long subframe, a slot, or the like. A TTI shorter than the common TTI may be referred to as a reduced TTI, a short TTI, a partial TTI (a partial or fractional TTI), a reduced subframe, a short subframe, a mini slot, a sub slot, a slot, or the like.

Furthermore, a long TTI (for example, a normal TTI, a subframe, or the like) may be replaced with a TTI having a time length exceeding 1 ms, and a short TTI (for example, a reduced TTI or the like) may be replaced with a TTI having a TTI length that is shorter than a TTI length of a long TTI and that is longer than or equal to 1 ms.

The resource block (RB) is a resource allocation unit in the time domain and the frequency domain and may include one or more consecutive subcarriers in the frequency domain. The number of subcarriers included in an RB may be the same irrespective of a numerology and may be, for example, 12. The number of subcarriers included in an RB may be determined based on a numerology.

Furthermore, a time domain of an RB may include one or more symbols and may be a length of one slot, one mini slot, one subframe, or one TTI. One TTI, one subframe, or the like may be formed of one or more resource blocks.

Furthermore, one or more RBs may be referred to as a physical resource block (PRB: Physical RB), a subcarrier group (SCG: Sub-Carrier Group), a resource element group (REG: Resource Element Group), a PRB pair, an RB pair, or the like.

Furthermore, the resource block may be formed of one or more resource elements (RE: Resource Element). For example, one RE may be a radio resource domain of one subcarrier and one symbol.

A bandwidth part (which may also be referred to as a partial bandwidth, etc.) may represent a subset of consecutive common resource blocks (RBs) for a certain numerology in a carrier. Here, a common RB may be identified by an index of RB based on a common reference point of the carrier. A PRB is defined in a BWP and may be numbered within that BWP.

BWP may include BWP for UL (UL BWP) and BWP for DL (DL BWP). In the terminal 20, one or more BWPs may be configured within one carrier.

At least one of the configured BWPs may be active, and the terminal 20 may not assume to transmit or receive predetermined signals/channels outside the active BWP. The terms “cell” and “carrier” in this disclosure may be replaced by “BWP”.

Structures of the radio frame, the sub frame, slot, the mini slot, and the symbol are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, a symbol length, a cyclic prefix (CP) length, and the like can be variously changed.

In the present disclosure, for example, when an article such as “a,” “an,” or “the” in English is added by a translation, the present disclosure may include a case in which a noun following the article is the plural.

In this disclosure, the term “A and B are different” may mean “A and B are different from each other”. Furthermore, the term may mean “A and B are different from C”. Terms such as “separated” or “combined” may be interpreted as well as “different”.

The aspects/embodiments described in the present disclosure may be used alone, used in combination, or switched with implementation. Notice of a given information (e.g. “X” notice) may also be given by implication (e.g. “no notice of the given information”), not explicitly.

In the present disclosure, the terminal coordination information is an example of the information relating to resource selection. PSCICH is an example of a channel that notifies a collision.

Although the present disclosure is described above in detail, it is obvious to those skilled in the art that the present disclosure is not limited to the embodiments described in the present disclosure. The present disclosure may be implemented as revised and modified embodiments without departing from the gist and scope of the present disclosure as set forth in claims. Accordingly, the description of the present disclosure is for the purpose of illustration and does not have any restrictive meaning to the present disclosure

This international patent application is based on and claims priority to Japanese Patent Application No. 2021-087198 filed on May 24, 2021, and the entire content of Japanese Patent Application No. 2021-087198 is incorporated herein by reference.

### DESCRIPTION OF SYMBOLS

10 base station
110 transmitter
120 receiver
130 setter
140 controller
terminal
210 transmitter
220 receiver
230 setter
240 controller
1001 processor
1002 storage device
1003 auxiliary storage device
1004 communication device
1005 input device
1006 output device

1. A terminal comprising:
a receiver configured to receive a signal from a first terminal and a second terminal in a resource pool;
a controller configured to detect overlap between a first reserved resource based on a signal received from the first terminal and a second reserved resource based on a signal received from the second terminal; and
a transmitter configured to transmit information relating to resource selection to the first terminal via a collision notification channel, in response to the controller detecting the overlap, wherein
when the first reserved resource includes a plurality of resources, the controller determines which collision notification channel associated with a resource of the plurality of resources to use for transmitting information relating to the resource selection.

2. The terminal as claimed in claim 1, wherein
the controller determines to transmit information relating to the resource selection via a collision notification channel associated with each of all resources in which the overlap has been detected from among the plurality of resources.

3. The terminal as claimed in claim 1, wherein
the controller determines to transmit information relating to the resource selection via a collision notification channel associated with any one of the plurality of resources in which the overlap has been detected.

4. The terminal as claimed in claim 3, wherein
the controller determines to transmit information relating to the resource selection via a collision notification channel associated with a resource that is the earliest in the time domain, from among the plurality of resources from which the overlap has been detected.

5. The terminal according to claim 1, wherein
the controller determines to transmit information relating to the resource selection via a collision notification channel associated with a resource that is the earliest in the time domain, from among the plurality of resources.

6. A communication method performed by a terminal, the communication method comprising:
receiving signals from a first terminal and a second terminal in a resource pool;
detecting overlap between a first reserved resource based on a signal received from the first terminal and a second reserved resource based on a signal received from the second terminal; and
transmitting information relating to resource selection to the first terminal via a collision notification channel, when the overlap is detected,
wherein
when the first reserved resource includes a plurality of resources, the terminal determines which collision notification channel associated with a resource of the plurality of resources to use for transmitting information relating to the resource selection.
